(19) United States
(12) Patent Application Publication
(10) Pub. No.: US 2006/0066270 A1
(43) Pub. Date: Mar. 30, 2006

(54) Controller for motor to be mounted on vehicle and electric power steering device and electric brake device using thereof

(75) Inventors: Shin Kumagai, Kanagawa (JP); Shigeru Endo, Kanagawa (JP); Atsushi Horikoshi, Kanagawa (JP); Kazunobu Nagai, Kanagawa (JP); Masahiro Kuroda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/231,904

(22) Filed: Sep. 22, 2005

(30) Foreign Application Priority Data
Sep. 22, 2004 (JP) P2004-274651

(51) Int. Cl. H02P 5/00

(52) U.S. Cl. 318/139; 318/108; 318/66; 318/90

(57) ABSTRACT

A controller for a motor to be mounted on a vehicle includes a boosting circuit 2 for raising the voltage of a battery that is disposed near the battery 1, a motor driving circuit 4 disposed near the motor 3 to be mounted on the vehicle for controlling the motor 3 to be mounted on the vehicle to be driven in accordance with boosted voltage outputted from the boosting circuit and a communication unit 5 disposed between the boosting circuit 2 and the motor driving circuit 4.

### BACKGROUND OF THE INVENTION

The present invention relates to a controller for a motor to be mounted on a vehicle that is driven by the electric power of a battery mounted on the vehicle and an electric power steering device and an electric brake device using the controller for the motor.

Generally, many motor controllers to be mounted on vehicles have been employed that control the supply of electric current to the motors to be mounted on the vehicles by using batteries as power sources. For instance, in an electric power steering device, a driver has hitherto detected a steering torque exerted on a steering wheel by a torque sensor and controlled the pulse width modulation (PWM) of the motor to drive the motor in accordance therewith to give an auxiliary steering force to a steering mechanism.

In recent years, not only a small vehicle, but also an intermediate vehicle or a large vehicle has been desired to be equipped with the electric power steering device so that the capacity of the motor or a controller thereof is increased. As for the motor, the use of a brush-less motor has been proposed in place of a motor with a brush in which electric current is restricted due to the brush. Further, the controller has been proposed to mount a boosting function thereon and obtain a higher output thereby.

As a usual example of the controller for the motor to be mounted on the vehicle that has the boosting function, for instance, an electric power steering device is proposed that includes a deciding unit for driving a motor for assisting a steering operation by a driving circuit to which voltage of a battery mounted on a vehicle is applied in accordance with a motor current command value determined on the basis of a steering torque to decide whether or not the motor current command value is larger than a first threshold value, an output unit for outputting a voltage boosting command for boosting the voltage of the battery mounted on the vehicle when the deciding unit decides that the motor current command value is larger than the first threshold value and a boosting circuit for boosting the voltage of the battery mounted on the vehicle in accordance with the outputted voltage boosting command (for instance, see Patent Document 1).

Further, as another usual example, an electric power steering device is proposed in which a target current value It to be supplied to a motor is calculated on the basis of the detected values of various kinds of sensors supplied to a microcomputer, a deviation between the target current value It and a detected current value Is is calculated to generate a command value V for a feedback control, a duty ratio Dc is calculated on the basis of the command value V, when the calculated duty ratio Dc exceeds a threshold value D0 such as 100%, a boosting circuit is activated to calculate an output duty ratio Dp (=Dc×Voff/Von) on the basis of the calculated duty ratio Dc, voltage Voff before voltage is boosted and voltage Von after voltage is boosted, when the output duty ratio is not larger than the threshold value D0, the boosting circuit is stopped to consider the calculated duty ratio Dc to be the output duty ratio Dp and the calculated output duty ratio Dp is supplied to a PWM signal generating circuit to control the motor to be driven.

[Patent Document 1]

JP-A-2001-260907 (see page 1, FIG. 4)

[Patent Document 2]

JP-A-2003-200838 (see page 1, FIG. 5)

However, in the usual examples disclosed in the above-described Patent Documents 1 and 2, the limit of the output of the battery relative to the large capacity of the electric steering device is considered. In this case, the motor needs to improve its efficiency, a controller needs to reduce its loss and wiring needs to reduce its loss. For the purpose of reducing the loss of the wiring among them, the decrease of a current value by a boosting function may be considered. However, in the electric power steering devices described in both the Patent Documents 1 and 2, since the boosting units are formed integrally with the motor driving units, below-described problems arise that have not been solved yet.

Specifically, as shown in FIG. 19, an example will be described in which assuming that a resistance of the wiring of a battery 101 and a motor 102 is 20 mΩ/wiring, a controller 103 including a motor driving circuit and a boosting circuit is arranged at a position of 9:1 in the vicinity of the motor 102. In this case, assuming that battery current Ib is direct current of 100 A, a motor rated current Im under the voltage boosting rate of 1 is 120 A in an effective value and the motor is set by optimizing a voltage specification depending on the voltage boosting rate, the relation of wiring loss to the voltage boosting rate α is shown in FIG. 20. Here, the wiring loss by the battery current Ib is obtained by a resistance value×(battery current Ib)²×the number of wiring (2). The wiring loss by the motor current Im is obtained by a resistance value×(motor current Im/voltage boosting rate α)²×the number of wiring (3). As apparent from FIG. 19, since the wiring loss is substantially occupied by the wiring loss by the battery current Ib, a non-solved problem undesirably arises that a wiring loss reducing effect by the boosted voltage is low.

As compared therewith, as shown in FIG. 21, assuming that a resistance of wiring of a battery 101 and a motor 102 is 20 mΩ/wiring, a controller 103 including a motor driving circuit and a boosting circuit is arranged at a position of 1:9 in the vicinity of the motor 102. In this case, when a battery current Ib and a motor current Im are assumed as described above, wiring loss relative to a voltage boosting rate α is shown in FIG. 22. As apparent from FIG. 22, when the voltage boosting rate α is adequately increased, the wiring loss reducing effect due to the boosted voltage can be exhibited. However, since the controller 103 is arranged in the vicinity of the battery 101, wiring for a resolver as a rotation sensor required between the motor 102 and the controller 103, wiring for a torque sensor and motor wiring are undesirably lengthened. Thus, an influence of noise or a cost-up due to the increase of the number of wiring, which is not yet solved, undesirably arises.

### SUMMARY OF THE INVENTION

Accordingly, the present invention is proposed by noticing the non-solved problems of the usual examples and it is an object of the present invention to provide a controller for a motor to be mounted on a vehicle in which wiring loss is reduced and a high output can be obtained and an electric power steering device and an electric brake device using it.

In order to achieve the above-described object, a controller for a motor to be mounted on a vehicle according to the present invention (defined in aspect 1) comprises a boosting unit for raising the voltage of a battery that is disposed near the battery; a motor driving unit disposed near the motor to be mounted on the vehicle for controlling the motor to be mounted on the vehicle to be driven in accordance with the boosted voltage outputted from the boosting unit; and a communication unit disposed between the boosting unit and the motor driving unit.

According to the invention defined in aspect 1, the boosting unit is disposed in the vicinity of the battery and the motor driving unit is disposed in the vicinity of the motor to be mounted on the vehicle. Thus, the voltage raised by the boosting unit is supplied to the motor driving unit to reduce wiring loss and a communication of data such as a boosted voltage control command between the motor driving unit and the boosting ‘unit’ is carried out through the communication unit.

Further, the controller for a motor to be mounted on a vehicle according to the invention (defined in aspect 2) is characterized in that the motor driving unit includes a motor rotating state detecting unit for detecting the rotating state of the motor to be mounted on a vehicle; a boosted voltage control command determining unit for determining a boosted voltage control command to the boosting unit on the basis of the rotating state of the motor detected by the motor rotating state detecting unit and a data transmitting unit for transmitting the boosted voltage control command determined by the boosted voltage control command determining unit to the boosting unit through the communication unit in the invention according aspect 1.

In the invention defined in aspect 2, the rotating state of the motor to be mounted on the vehicle is detected by the motor rotating state detecting unit. The boosted voltage control command of the boosting unit is determined by the boosted voltage control command determining unit on the basis of the detected rotating state of the motor. The determined boosted voltage control command is transmitted to the boosting unit by the data transmitting unit through the communication unit so that the boosted voltage outputted from the boosting unit is controlled.

Further, the controller for a motor to be mounted on a vehicle according to the invention (defined in aspect 3) is characterized in that the motor rotating state detecting unit includes a rotating speed detecting unit for detecting the rotating speed of the motor to be mounted on a vehicle in the invention according to aspect 2.

In the invention defined in aspect 3, the rotating state of the motor to be mounted on the vehicle, that is, the rotating speed of the motor is detected by the rotating speed detecting unit composed of a resolver so that the change of the rotating state can be precisely detected.

Still further, the controller for a motor to be mounted on a vehicle according to the invention (defined in aspect 4) is characterized in that the motor rotating state detecting unit includes a rotating acceleration detecting unit for detecting the rotating acceleration of the motor to be mounted on a vehicle in the invention according to aspect 2.

In the invention defined in aspect 4, the rotating acceleration of the motor in the rotating state of the motor to be mounted on the vehicle is detected by the rotating acceleration detecting unit to precisely detect the change of the rotating state.

Still further, the controller for a motor to be mounted on a vehicle according to the present invention (defined in aspect 5) is characterized in that the boosting unit includes a boosted voltage control unit for controlling a boosted output voltage in accordance with the boosted voltage control command transmitted from the data transmitting unit of the motor driving unit in the invention according to aspect 2.

In the invention defined in aspect 5, when the boosting unit receives the boosted voltage control command from the motor driving unit through the communication unit, the boosting unit controls the boosted output voltage in accordance with the boosted voltage control command to output a boosted output voltage necessary for the motor driving unit.

The controller for a motor to be mounted on a vehicle according to the present invention (defined in aspect 6) is characterized in that the boosting unit include a boosted output voltage detecting unit for detecting the boosted output voltage and a data transmitting unit for transmitting the boosted output voltage detected by the boosted output voltage detecting unit to the motor driving unit through the communication unit in the invention according to any one of aspects 1 to 5.

In the invention defined in aspect 6, the boosted output voltage detecting unit detects the boosted output voltage of the boosting unit and transmits the detected boosted output voltage to the motor driving unit by the data transmitting unit through the communication unit. Accordingly, the motor driving unit can decide various kinds of abnormalities on the basis of the boosted output voltage.

Further, the controller for a motor to be mounted on a vehicle according to the invention (defined in aspect 7) is characterized in that the motor driving unit includes an applied voltage detecting unit for detecting applied voltage inputted from the boosting unit and a current abnormality detecting unit for detecting the abnormality of the current of the motor driving unit on the basis of the boosted output voltage transmitted from the boosting unit and the applied voltage detected by the applied voltage detecting unit in the invention according to aspect 6.

In the invention defined in aspect 7, the abnormality of the current of the motor driving unit is detected by the current abnormality detecting unit on the basis of the applied voltage inputted from the boosting unit that is detected by the applied voltage detecting unit and the boosted output voltage transmitted from the boosting unit.

Still further, the controller for a motor to be mounted on a vehicle according to the present invention (defined in aspect 8) is characterized in that the motor driving unit includes an estimated voltage calculating unit for calculating an estimated boosted output voltage of the boosting unit in accordance with the boosted voltage control command determined by the boosted voltage control command determining unit and a boosted voltage abnormality detecting unit for detecting the abnormality of the boosting unit on the basis of the estimated boosted output voltage calculated by the estimated voltage calculating unit and the boosted output voltage transmitted from the boosting unit in the invention according to aspect 6.

In the invention defined in aspect 8, the estimated voltage calculating unit calculates the estimated boosted output voltage of the boosting unit in accordance with the boosted voltage control command determined by the boosted voltage control command determining unit The boosted voltage abnormality detecting unit detects the abnormality of the boosting unit on the basis of the calculated estimated boosted output voltage and the boosted output voltage transmitted from the boosting unit.

Still further, the controller for a motor to be mounted on a vehicle according to the present invention (defined in aspect 9) is characterized in that the communication unit performs a serial data communication in the invention according to any one of aspects 1 to 8.

In the invention defined in aspect 9, a communication between the boosting unit and the motor driving unit is performed by the serial data communication to suppress an influence of noise by a digital communication.

Further, the controller for a motor to be mounted on a vehicle according to the present invention (defined in aspect 10) is characterized in that the communication unit performs an optical data communication in the invention according to any one of aspects 1 to 8.

In the invention defined in aspect 10, the communication between the boosting unit and the motor driving unit is performed by the optical data communication to suppress an influence of noise by an optical digital communication.

Further, an electric power steering device according to the present invention (defined in aspect 11) is characterized in that the controller for a motor to be mounted on a vehicle according to any one of aspects 1 to 10 is mounted.

In the invention defined in aspect 11, the electric power steering device that can reduce wiring loss and have a high output can be provided.

Furthermore, an electric brake device according to the present invention (defined in aspect 12) is characterized in that the controller for a motor to be mounted on a vehicle according to any one of aspects 1 to 10 is mounted.

In the invention defined in aspect 12, the electric brake device that can reduce wiring loss and have a high output can be provided.

The present invention is proposed by considering the above-described circumstances and it is an object of the present invention to provide a controller for a motor to be mounted on a vehicle in which wiring loss can be reduced and the increase of the number of wiring whose wiring distance is lengthened: can be suppressed and a power steering device having the controller for a motor.

To achieve the above-described object, a controller for a motor to be mounted on a vehicle according to the present invention (defined in aspect 13) comprises: a boosting circuit part disposed in the vicinity of a battery mounted on the vehicle to raise the output voltage of the battery; and a driving control part disposed in the vicinity of a motor to which a driving power is supplied by the battery to PWM control the drive of the motor in accordance with the voltage boosted by the boosting circuit part.

That is, the boosting circuit part is arranged in the vicinity of the battery to boost the battery voltage. Thus, a high voltage and low current can be achieved in wiring lengthened between the boosting circuit part and the motor and wiring loss can be reduced. On the other hand, the driving control part is disposed in the vicinity of the motor. Thus, since the driving control circuit obtains various kinds of information of the motor necessary for a driving control. Thus, a wiring distance for obtaining output signals of sensors disposed near the motor side is shortened.

Further, a power steering device according to the present invention (defined in aspect 24) includes the controller for a motor to be mounted on a vehicle according to any one of aspects 13 to 23. A steering drive is assisted by the output torque of the motor. That is, the motor of the power steering device is ordinarily disposed in the vicinity of a steering shaft. Then, to drive the motor and assist the steering power of a driver, information such as the rotating position of the steering shaft or a torque exerted on the shaft needs to be obtained by using a rotating position detecting sensor or a torque sensor or the like. Accordingly, the position of the motor is separated from the battery. Further, the wiring of various kinds of sensor signals needs to be pulled around between the controller and the motor. Accordingly, when the controller for a motor to be mounted on a vehicle of the present invention is applied to the power steering device, the above-described problems caused by the form of the system can be solved.

According to the invention defined in aspect 1, the controller for a motor to be mounted on a vehicle that can minimize wiring loss and can obtain a high output can be effectively obtained.

Further, according to the invention defined in aspect 2, since the necessary boosted voltage is obtained from the rotating state of the motor in the motor driving unit to determine the boosted voltage control command of the boosting unit and the boosted voltage control command is transmitted to the boosting unit through the communication unit, the boosted voltage of the boosting unit can be effectively controlled to a proper state.

Further, according to the invention defined in aspect 3, the rotating speed of the motor in the rotating state of the motor to be mounted on a vehicle is detected by the rotating speed detecting unit composed of the resolver. Accordingly, the change of the rotating state can be effectively accurately detected.

Still further, according to the invention defined in aspect 4, the rotating acceleration of the motor in the rotating state of the motor to be mounted on a vehicle is detected by the rotating acceleration detecting unit. Accordingly, the change of the rotating state can be effectively accurately detected.

Still further, according to the invention defined in aspect 5, since the boosting unit controls the boosted output voltage in accordance with the boosted voltage control command transmitted from the motor driving unit, an optimum boosted output voltage required by the motor driving unit can be effectively outputted to the motor driving unit.

Further, according to the invention defined in aspect 6, the boosted output voltage of the boosting unit is detected in the boosted output voltage detecting unit and the detected boosted output voltage is transmitted to the motor driving unit by the data transmitting unit through the communication unit. Thus, various kinds of abnormalities can be effectively decided on the basis of the boosted output voltage in the motor driving unit.

Further, according to the invention defined in aspect 7, the current abnormality detecting unit can effectively detect the abnormality of the current of the motor driving unit on the basis of the applied voltage inputted from the boosting unit that is detected by the applied voltage detecting unit and the boosted output voltage transmitted from the boosting unit. The motor driving unit does not need to have a shunt resistance for detecting abnormal current.

Still further, according to the invention defined in aspect 8, the estimated voltage calculating unit can effectively calculate the estimated boosted output voltage of the boosting unit on the basis of the boosted voltage control command determined by the boosted voltage control command determining unit. The boosted voltage abnormality detecting unit can effectively detect the abnormality of the boosting unit on the basis of the calculated estimated boosted output voltage and the boosted output voltage transmitted from the boosting unit.

According to the invention defined in aspect 9, the communication between the boosting unit and the motor driving unit is performed by the serial data communication so that the influence of noise can be effectively suppressed.

Further, according to the invention defined in aspect 10, the communication between the boosting unit and the motor driving unit is performed by the optical data communication so that the influence of noise can be effectively suppressed by the optical digital communication.

Further, according to the invention defined in aspect 11, the electric power steering device that can reduce the wiring loss and have the high output can be provided. The motor to be mounted on a vehicle that generates an assistance for steering upon sudden steering such as upon emergent avoidance can be effectively rapidly driven with high responsiveness.

Still further, according to the invention defined in aspect 12, the electric brake device that can reduce the wiring loss and have the high output can be provided. The motor to be mounted on a vehicle that operates an electric brake upon sudden braking such as upon emergent braking can be effectively rapidly driven with high responsiveness.

In the controller for a motor to be mounted on a vehicle according to the present invention, wiring loss can be minimized and a high motor output can be obtained in a limited battery output. Then, the controller for a motor to be mounted on a vehicle of the present invention is applied so that a power steering device of a high output can be constructed.

### BRIEF DESCRIPTION OF THE DRAWINGS

FIG. 1 is a block diagram showing an embodiment in which the present invention is applied to an electric power steering device.

FIG. 2 is a block diagram showing one example of boosting circuit to which the present invention is applicable.

FIG. 3 is a flowchart showing one example of a signal transmitting procedure performed by a microcomputer of the boosting circuit.

FIG. 4 is a flowchart showing one example of a boosted voltage control procedure performed by the microcomputer of the boosting circuit.

FIG. 5 is a block diagram showing one example of a motor driving circuit to which the present invention is applicable.

FIG. 6 is a flowchart showing one example of an auxiliary steering control procedure performed by a microcomputer of the motor driving circuit.

FIG. 7 is a characteristic diagram showing an auxiliary steering current value calculating map.

FIG. 8 is a flowchart showing one example of a boosted voltage control procedure performed by the microcomputer of the motor driving circuit.

FIG. 9 is a characteristic diagram showing a duty ratio calculating control map.

FIG. 10 is a flowchart showing one example of an abnormality detecting procedure performed by the microcomputer of the motor driving circuit.

FIGS. 11A and 11B are time chart for explaining a steering control operation.

FIG. 12 is a characteristic diagram showing the relation between a motor rotating speed and an output torque.

FIG. 13 is a characteristic diagram for explaining a voltage drop due to wiring resistance.

FIGS. 14A to 14C are time chart for explaining a boosted voltage control operation upon steering for avoiding an emergency.

FIG. 15 is a characteristic diagram showing motor characteristics in a boosted voltage control.

FIG. 16 is a circuit diagram for explaining wiring resistance in the present invention.

FIG. 17 is a characteristic view showing the relation between a voltage boosting rate and wiring loss in the present invention.

FIG. 18 is a block diagram showing an embodiment in which the present invention is applied to an electric brake device.

FIG. 19 is a circuit diagram showing a usual example in which a controller is disposed in the vicinity of a motor to be mounted on a vehicle.

FIG. 20 is a characteristic view showing the relation between a voltage boosting rate and wiring loss of FIG. 19.

FIG. 21 is a circuit diagram showing a usual example in which a controller is disposed in the vicinity of a battery.

FIG. 22 is a characteristic view showing the relation between a voltage boosting rate and wiring loss of FIG. 21.

FIG. 23 shows one embodiment of an electric power steering device to which the present invention is applied and shows a functional block diagram of the entire structure of the device.

FIG. 24 is a diagram showing an electric structure of a boosting circuit part.

FIG. 25 is a diagram showing an electric structure of a driving control part.

FIGS. 26A and 26B are flowcharts mainly showing the contents of processes of a communication performed between a microcomputer of the boosting circuit side and a microcomputer of the driving control side.

FIG. 27 is a diagram showing one example of the relation between the rotating speed of a brush-less motor and a boost voltage command.

FIG. 28 is a diagram showing a state that the driving control part is provided at a position of 9:1 in the vicinity of a motor and the boosting circuit part is provided at a position of 1:9 in the vicinity of a battery between the battery and the motor.

FIG. 29 is a diagram showing a state that wiring loss changes when the voltage boosting rate of the boosting circuit part is changed on the basis of the form of the arrangement shown in FIG. 28.

### DETAILED DESCRIPTION OF THE PREFERRED EMBODIMENTS

Now, embodiments of the present invention will be described by referring to the drawings.

### First Embodiment

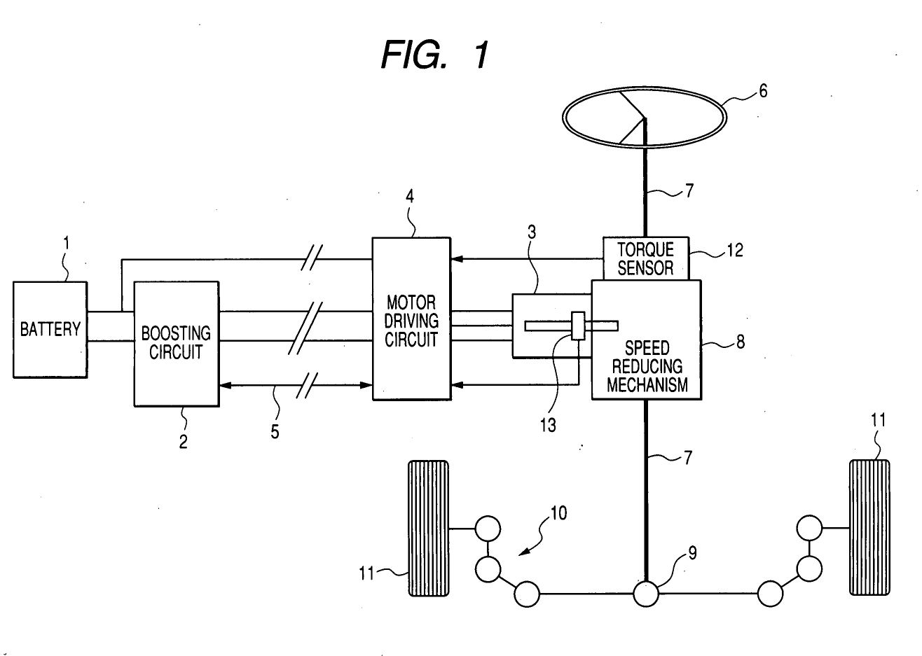

FIG. 1 is a block diagram showing a schematic structure of a first embodiment when the present invention is applied to an electric power steering device. In the drawing, reference numeral 1 designates a battery having a rated voltage of 12V that is mounted on an ordinary vehicle. Battery power outputted from the battery 1 is supplied to a boosting circuit 2 as a boosting unit disposed near the battery 1. A boosted output voltage raised in the boosting circuit 2 is inputted to a motor driving circuit 4 as a motor driving unit disposed near a motor 3 to be mounted on a vehicle that generates a steering assist force. To the motor driving circuit 4, the battery power of the battery 1 is supplied as controlling electric power. A communication line 5 as a communication unit for performing a data communication is disposed between the motor driving circuit 4 and the boosting circuit 2.

Here, the motor 3 to be mounted on a vehicle is composed of a brush-less motor driven by three-phase alternating current and operates as a steering assist force generating motor for generating a steering assist torque of the electric power steering device. The motor 3 to be mounted on a vehicle is connected to a steering shaft 7 to which a steering wheel 6 is connected through a speed reducing mechanism 8. This steering shaft 7 is connected to a rack and pinion mechanism 9. The rack and pinion-mechanism 9 is connected to right and left rolling and steering wheels 11 through connecting mechanisms 10 such as tie rods.

In the steering shaft 7, a steering torque sensor 12 for detecting a steering torque inputted to the steering wheel 6 is provided. In the motor 3 to be mounted on a vehicle, a resolver 13 for detecting the rotating angle of the motor is provided. A steering torque detecting signal detected in the steering torque sensor 12 and a motor rotating angle detecting signal detected in the resolver 13 are inputted to the motor driving circuit 4.

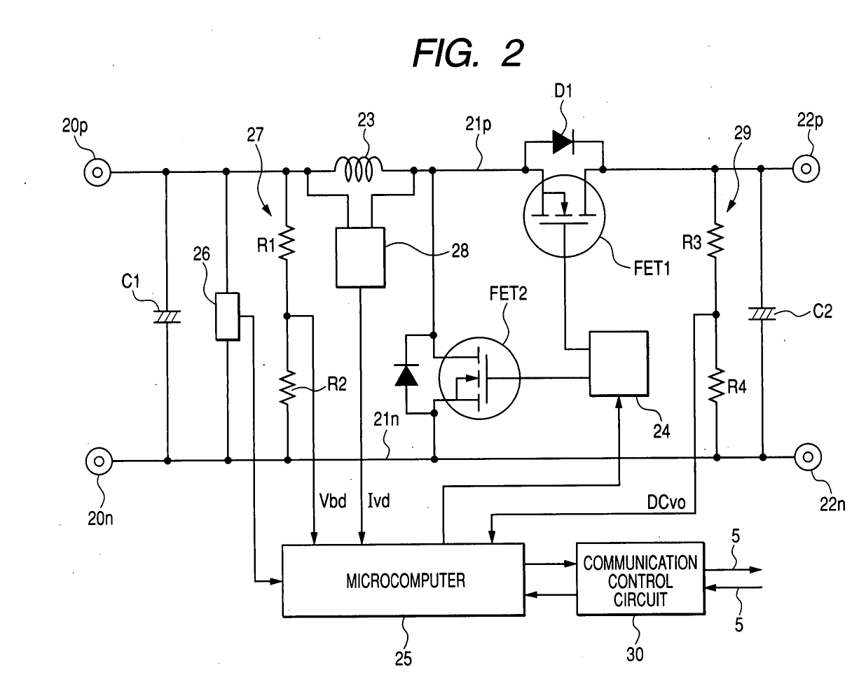

The boosting circuit 2 includes, as shown in FIG. 2, input terminals 20P and 20n connected to an anode side terminal 1p and a cathode side terminal in of the battery 1 and output terminals 22p and 22n connected to the input terminals 20p and 20n through an anode line 21p and a cathode line 21n.

To the anode line 21p, a reactor 23 and the source and the drain of a field effect transistor FET1 as a switching element are connected in series and interposed. Between the source and the drain of the field effect transistor FET1, a diode D1 having an anode connected to the source and a cathode connected to the drain is connected. Further, between a node of the reactor 23 and the source of the field effect transistor FET1 and the cathode line 21n, a field effect transistor FET2 as a switching element is interposed that has a drain provided in the reactor 23 side and a source provided in the cathode line 21n side. Then, the gates of the field effect transistors FET1 and FET2 are connected to a gate drive circuit 24. To the gate drive circuit 24, a pulse width modulation (PWM) signal outputted from a microcomputer 25 is inputted.

Further, between the input terminals 20p and 20n, a smoothing condenser C1 is connected. A power circuit 26 for generating a control power to the microcomputer 25 for controlling the boosting circuit 2 is connected in parallel with the smoothing condenser C1. Further, a potential dividing circuit 27 for dividing battery voltage Vb to 1/10 in which resistances R1 and R2 connected in series is connected in parallel with the power circuit 26. A battery voltage detecting signal Vbd outputted from the node of the resistances R1 and R2 of the potential dividing circuit 27 is inputted to an A/D converting input terminal of the microcomputer 25. Further, a current detecting circuit 28 for shifting and amplifying the levels of both end voltages is connected to both the ends of the reactor 23. A current detecting signal Ivd detected in the current detecting circuit 28 is inputted to the A/D converting input terminal of the microcomputer 25.

Similarly, between the output terminals 22p and 22n, a smoothing condenser C2 is connected. A potential dividing circuit 29 for dividing boosted output voltage DCvo to 1/10 in which resistances R3 and R4 are connected in series is connected in parallel with the smoothing condenser C2. A boosted output voltage detecting signal outputted from the node of the resistances R3 and R4 of the potential dividing circuit 29 is inputted to the A/D converting input terminal of the microcomputer 25.

Further, to the microcomputer 25, a communication control circuit 30 is connected that receives a transmitting packet in which a below-described boosted voltage controlling duty ratio D is stored as a digital data signal with a form of serial data from the motor driving circuit 4 through the communication line 5, and transmits a transmitting packet in which the battery voltage detecting value Vb and the boosted output voltage detecting value DCvo is stored as digital data signals with the form of serial data to a communication control circuit 51 of the motor driving circuit 4 through the communication line 5.

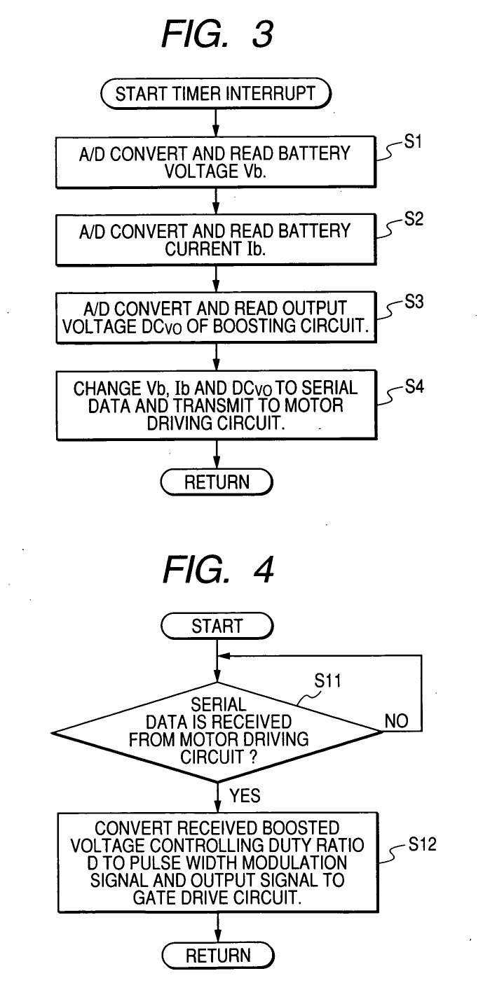

Then, the microcomputer 25 performs a signal transmitting process shown in FIG. 3 and a boosted voltage control-process shown in FIG. 4.

The signal transmitting process is performed as a timer interrupt process at intervals of prescribed sampling cycles as shown in FIG. 3. Firstly, in step S1, the battery voltage Vb inputted from the potential dividing circuit 27 is A/D converted and read. Then, the step shifts to step S2 to A/D convert and read battery current Ib detected in the current detecting circuit 28. Then, the step is shifted to step S3. The boosted output voltage DCvo inputted from the potential dividing circuit 29 is A/D converted and read. Then, the step is shifted to step S4. The battery voltage Vb, the battery current Ib and the boosted output voltage DCvo of the read digital values are stored as the digital data signals with the form of serial data in the transmitting packet to be transmitted to a microcomputer 46 of the motor driving circuit 4. The transmitting packet is outputted to the communication control circuit 30 to finish the timer interrupt process and return to a prescribed main program.

Further, the boosted voltage control process is shown in FIG. 4. Firstly, in step S11, it is decided whether or not a transmitting packet to the microcomputer itself in which a digital data signal with the form of serial data including the duty ratio D of a boosted voltage control pulse is received from the motor driving circuit 4. When the transmitting packet is not received, the process is waited for until the transmitting packet is received. When the transmitting packet is received, the step shifts to step S12 to from a pulse width modulation (PWM) signal corresponding to the boosted voltage controlling duty ratio D stored in the received transmitting packet. The pulse width modulation signal is outputted to the gate drive circuit 24 and then the step returns to the step S11.

Here, in the processes shown in FIGS. 3 and 4, the process of the step S3 in FIG. 3 and the potential dividing circuit 29 correspond to a boosted output voltage detecting unit. The process of the step S4 corresponds to a data transmitting unit. The processes of FIG. 4 correspond to a boosted voltage control unit.

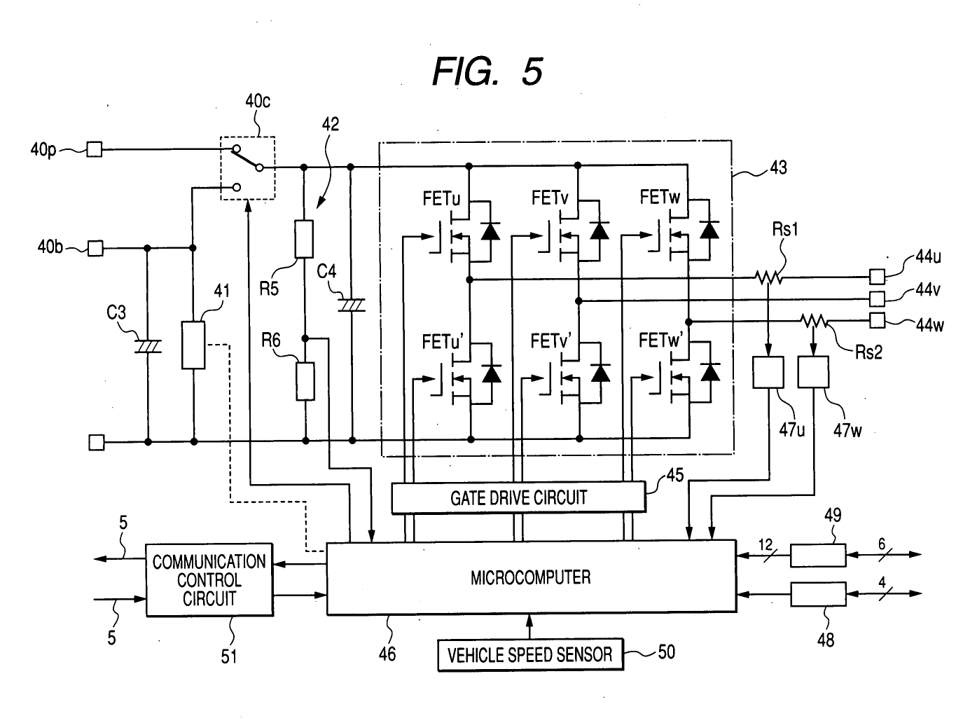

Further, as shown in FIG. 5, the motor driving circuit 4 includes input terminals 40p and 40n connected to the output terminals 22p and 22n of the boosting circuit 2 through connecting lines 31p and 31n, a battery voltage input terminal 40b connected to the anode terminal 1p of the battery 1 and a selecting switch 40c for selecting the input terminal 40p and the battery voltage input terminal 40b. Between the battery voltage input terminal 40b and the input terminal 40n, a smoothing condenser C3 is connected. A power circuit 41 for generating a control power to the microcomputer 46 for controlling a below-described inverter circuit is connected in parallel with the smoothing condenser C3. Further, between the output side of the selecting switch 40c and the input terminal 40n, a potential dividing circuit 42 having resistances R5 and R6 connected in series is connected. A smoothing condenser C4 is connected in parallel with the potential dividing circuit 42. An inverter circuit 43 is connected in parallel with the smoothing condenser.

The inverter circuit 43 has a structure of a three-phase bridge including a series circuit of field effect transistors FETu and FETu′ as switching elements connected in parallel with the smoothing condenser C4, a series circuit of field effect transistors FETv and FETv′ connected in parallel with the series circuit and a series circuit of field effect transistors FETw and FETw′ connected in parallel with the series circuit. Then, motor output terminals 44u and 44w are led through shunt resistances Rs1 and Rs2 respectively from the nodes of the field effect transistors FETu and FETu′ and the field effect transistors FETw and FETw′ of the series circuits. A motor output terminal 44v is directly led from the node of the field effect transistors RFETv and FETv′. Further, a gate drive circuit 45 is provided for supplying on/off signals respectively to the gates of the field effect transistors FETu to FETw and FETu′ to FETw′ forming the inverter circuit 43, The microcomputer 46 is provided for outputting a pulse width modulation (PWM) signal to the gate drive circuit 45.

In the microcomputer 46, an applied voltage detecting signal DC_{VI} obtained by dividing the boosted output voltage of the boosting circuit 2 inputted to the input terminals 40p and 40n that is outputted from the node of the resistances R5 and R6 of the above-described potential dividing circuit 42 to 1/10 is supplied to an A/D converting input terminal. Current detecting signals Imu and Imw of current detecting circuits 47u and 47w are inputted to the A/D converting input terminal, which are connected to both the ends of the shunt resistances Rs1 and Rs2 and output the current detecting signals Imu and Imw that are obtained by amplifying the voltage of both the ends 20 times as high as, for instance, 2.5V as a reference capable of being inputted to the microcomputer 46. Further, to the microcomputer 46, the steering torque signal detected in the steering torque sensor 12 is inputted. A steering torque detecting signal T from a torque detecting circuit 48 for detecting a steering torque in accordance therewith is inputted to the A/D converting input terminal. A motor rotating angle signal θ_{M} from a motor rotating angle detecting circuit 49 for outputting a motor rotating angle signal to which an output signal of the resolver 13 is inputted is inputted to an input terminal. Further, a vehicle speed detecting signal outputted from a vehicle speed sensor 50 for detecting a vehicle speed is inputted to the microcomputer.

Here, the motor rotating angle detecting circuit 49 supplies an exciting signal to the resolver 13 and receives cosine wave and sine wave signals outputted from the resolver 13 to detect a motor rotating angle on the basis of them. The motor rotating angle detecting circuit converts the motor rotating angle to a digital value to supply a digital signal of 12 bits to the input terminal of the microcomputer 46.

Further, the microcomputer 46 includes a communication control circuit 51 as a communication unit that transmits to the boosting circuit 2 through the communication line 5 a transmitting packet in which a digital data signal having a boosted voltage controlling duty ratio D as the boosted voltage control command of the boosting circuit 2 determined by a below-described boosted voltage control process converted to serial data is stored and receives a transmitting packet in which digital data with the form of serial data transmitted from the boosting circuit 2 is stored and inputs the transmitting packet to the microcomputer 46.

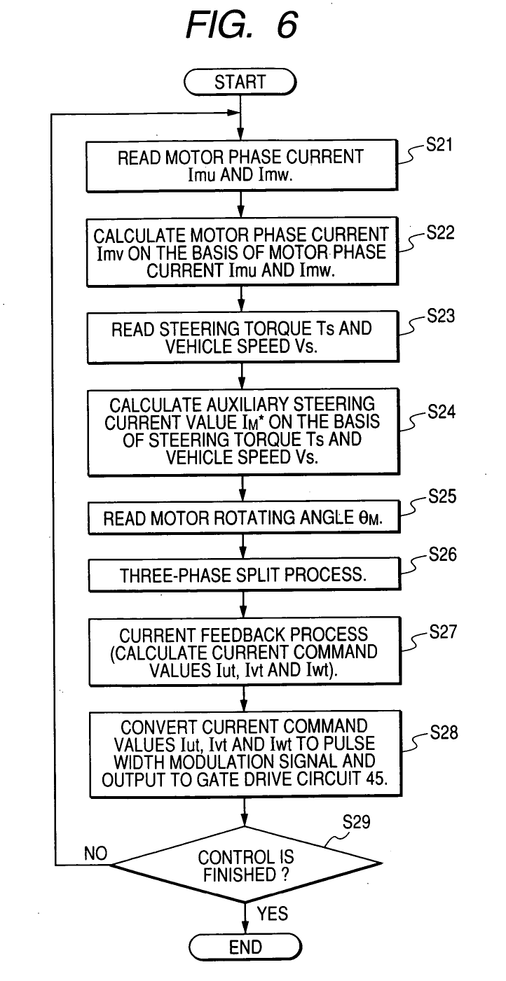

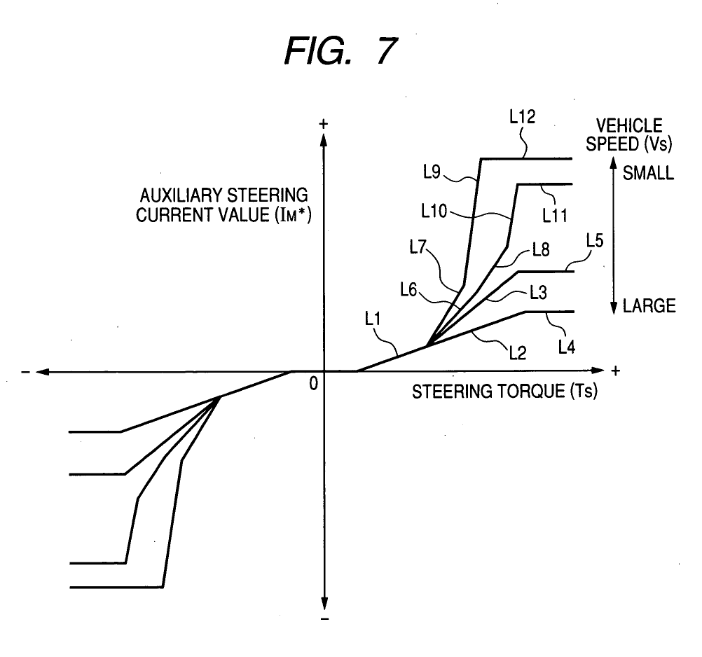

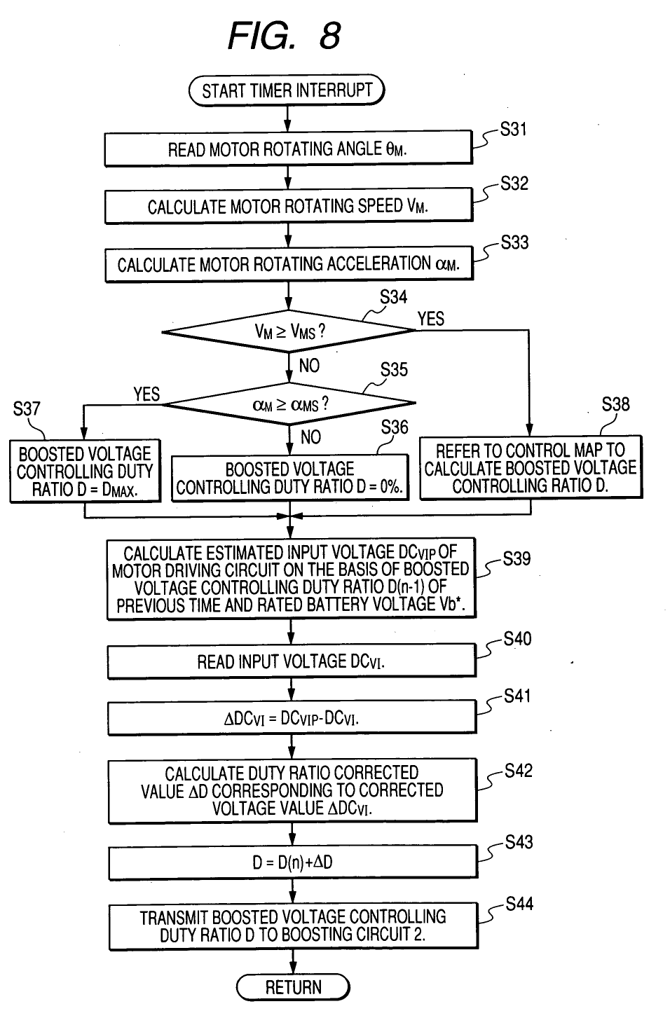

Then, in the microcomputer 46, an auxiliary steering control process shown in FIG. 6, the boosted voltage control process shown in FIG. 7 and an abnormality detecting process shown in FIG. 8 are performed.

In the auxiliary steering control process, as shown in FIG. 6, phase currents Imu and Imw to be outputted to the motor 3 to be mounted on a vehicle that are detected in the current detecting circuits 47u and 47w are initially read in step S21. Then, the step shifts to step S22 to calculate a phase current Imv on the basis of the read phase currents Imu and Imw, Then, the step shifts to step S23 to read the steering torque Ts detected in the torque detecting circuit 48 and the vehicle speed Vs detected in the vehicle speed sensor 50, and then, shift to step S24.

In the step S24, an auxiliary steering command value I_{M}* represented by a motor command current value is calculated by referring to an auxiliary steering command value calculating map shown in FIG. 7 on the basis of the read steering torque Ts and the vehicle speed Vs.

Here, the auxiliary steering command value calculating map is formed by a characteristic diagram including, as shown in FIG. 7, the steering torque detecting value T in an axis of abscissa, the auxiliary steering command value I_{M}* in an axis of ordinate and the vehicle speed detecting value Vs as a parameter. Four characteristic lines are formed that include a straight line part L1 extending with a relatively gentle gradient irrespective of the vehicle speed detecting value Vs until the steering torque Ts reaches a first setting value Ts1 after the steering torque Ts increases in a positive direction from “0”, straight line parts L2 and L3 extending with a relatively gentle gradient while the vehicle speed detecting value Vs is relatively high when the steering torque Ts increases more than the first setting value Ts1, straight line parts L4 and L5 parallel to the axis of abscissa in the vicinity of a second setting value Ts2 larger than the first setting value Ts1 of the steering torque detecting value Ts, straight line parts L6 and L7 with a relatively large gradient while the vehicle speed detecting value Vs is low, straight line parts L8 and L9 having a gradient larger than that of the straight line parts L6 and L7, a straight line part L10 having a gradient larger than that of the straight line part L8 and straight line parts L11 and L12 extending in parallel with the axis of abscissa from the terminal ends of the straight line parts L9 and L10. Similarly, when the steering torque Ts increases in a negative direction, four characteristic lines are formed with a point symmetry relative to the above-described lines with respect to an origin.

Then, the step shifts to step S25. The motor rotating angle θ_{M} detected in the motor rotating angle detecting circuit 49 is read. Then, the step shifts to step S26. A three-phase split process is carried out for converting a U-phase, a V-phase and a W-phase of the motor 3 to be mounted on a vehicle to target phase current values Imu*, Imv* and Imw* on the basis of the auxiliary steering command value I_{M}* calculated in the step 24 and the motor rotating angle θ_{M}. Then, the step shifts to step S27.

In the step S27, a current feed back process is carried out for performing a PID process to a deviation between values to calculate current command values Iut, Ivt and Iwt on the basis of the motor phase currents Imu and Imw read in the step S21 and the motor phase current Imv calculated in the step S22 and the target phase current values Imu*, rmv* and Tmw* converted in the step S26. Then, the step shifts to step S28 to form pulse width modulation (PWM) signals corresponding to the calculated current command values Iut, Ivt and Iwt of the phases and output the signals to the gate drive circuit 45, and then, return to the step S21.

Further, the boosted voltage control process is performed as a timer interrupt process at intervals of prescribed sampling cycles. As shown in FIG. 8, in step S31, the motor rotating angle θ_{M} detected in the motor rotating angle detecting circuit 49 is read. Then, the step shifts to step S32 to differentiate the motor rotating angle θ_{M} and calculate a motor rotating speed V_{M}. Then, the step shifts to step S33 to differentiate the motor rotating speed V_{M} and calculate a motor rotating acceleration αM and then shift to step S34.

In the step S34, it is decided whether or not the motor rotating speed V_{M} calculated in the step S32 is a preset motor rotating speed setting value V_{MS} or higher. When V_{M} is lower than V_{MS}, it is decided that the motor rotating speed is located within an ordinary range to shift the step to step S35. Then, it is decided that the motor rotating acceleration αM calculated in the step S33 is a preset motor rotating acceleration setting value αMS or higher. When αM is lower than αMS, it is decided that the motor rotating acceleration αM is located within an ordinary range to shift the step to step S36. Then, the boosted voltage controlling duty ratio D is set to “0” % so that a voltage boosting rate α (=DCvo/Vb) in the boosting circuit 2 is “1”. Then, the step shifts to step S39.

When the decided result of the step S35 is αM≧αMS, it is decided that a state is a sudden steering state such as at the time of an emergent avoidance to shift the step to step S37. Then, an upper limit duty ratio D_{MAX} in which the voltage boosting rate α is “3” as the boosted voltage controlling duty ratio D is set, and then the step shifts to step S39.

On the other hand, when the decided result of the step S34 is V_{M}≧V_{MS}, the step shifts to step S38. Then, the boosted voltage controlling duty ratio D is calculated by referring to a duty ratio calculating control map shown in FIG.9 on the basis of the motor rotating speed V_{M}. Here, the duty ratio calculating control map is set, as shown in FIG. 9, in such a way that when the motor rotating speed V_{M} is the setting value V_{MS}, the boosted voltage controlling duty ratio D is set to “0”%, when the motor rotating speed V_{M} increases more than the setting value V_{MS}, the boosted voltage controlling duty ratio D increases in proportion thereto and when the boosted voltage controlling duty ratio D reaches, for instance, the preset upper limit duty ratio D_{MAX} (for instance, 66.6%) in which the boosted voltage control voltage DCvo outputted from the boosting circuit 2 becomes three times as high as the battery voltage Vd, that is, the voltage boosting rate α is “3”, the upper limit duty ratio D_{MAX} is maintained thereafter irrespective of the increase of the motor rotating speed V_{M}.

In step S39, an estimated input voltage DC_{VIP} required in the motor driving circuit 4 is calculated on the basis of the voltage boosting rate α based on the boosted voltage controlling duty ratio D (n-1) of a previous time calculated in any of the steps S36, S37 and S38 of a previous sampling cycle and the rated battery voltage Vb * of the battery 1. Then, the step sifts to step S40. Then, an input voltage DC_{VI} inputted from the boosting circuit 2 is read. Then, the step shifts to step S41. Then, input voltage DC_{VI} is subtracted from the estimated input voltage DC_{VIP} to calculate a corrected voltage value Δ DC_{VI} (=DC_{VIP}−DC_{VI}) as a deviation between them. Then, the step shifts to step S42.

In the step S42, a boosted voltage controlling duty ratio corrected value Δ D corresponding to the calculated corrected voltage value Δ DC_{VI} is calculated. Then, the step shifts to step S43 to set a value obtained by adding the boosted voltage controlling duty ratio corrected value Δ D to a boosted voltage controlling duty ratio D(n) calculated in any one of the steps S36, S37 and S38 as a boosted voltage controlling duty ratio D of this time (=D(n)+AD). Then, the step shifts to step S44 to convert the boosted voltage controlling duty ratio D to a digital signal with the form of serial data and store the digital signal in a transmitting packet to be transmitted to the microcomputer 25 of the boosting circuit 2 and transmit the transmitting packet to the communication line 5. Then, the timer interrupt process is finished to return to a prescribed main program.

The process shown in FIG. 8 corresponds to a boosted voltage control command determining unit.

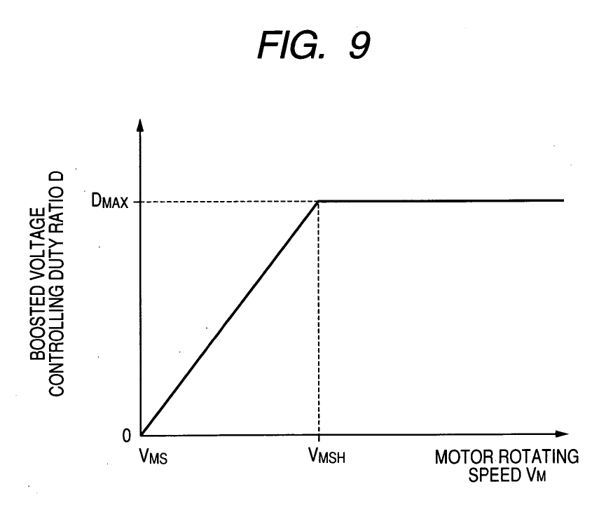

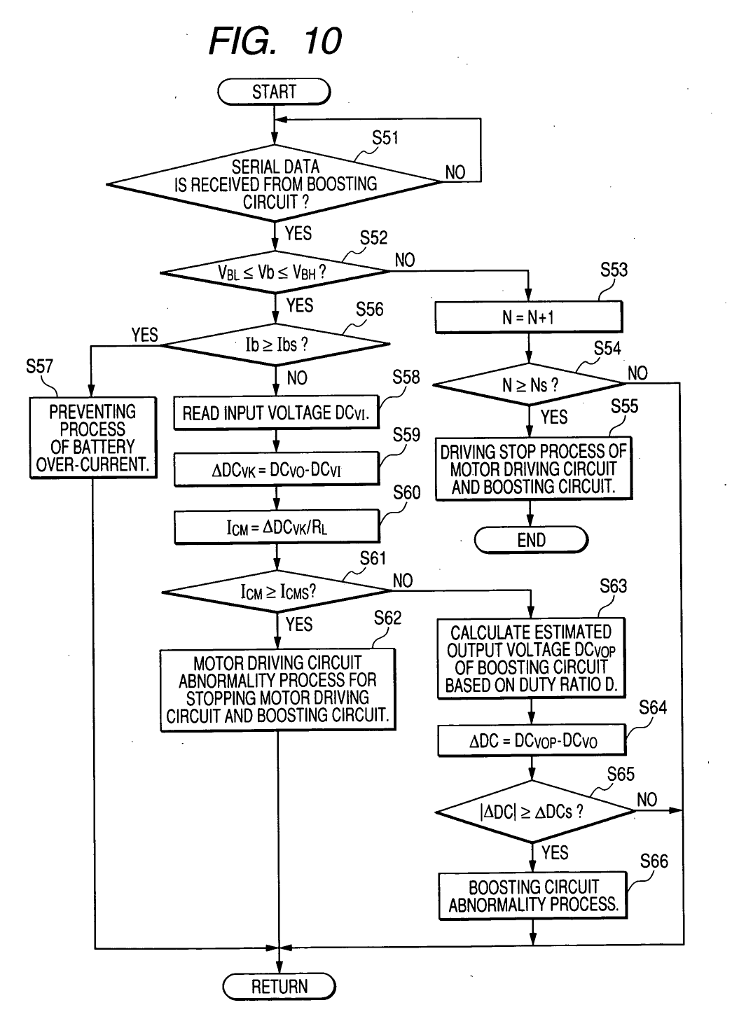

Further, the abnormality detecting process is shown in FIG. 10. In step S51, it is firstly decided whether or not the transmitting packet in which the digital data signal with the form of serial data is stored is received from the boosting circuit 2. When the transmitting packet is not received, the process is waited for until the transmitting packet is received. When the transmitting packet is received, the step shifts to step S52 to decide whether or not the battery voltage Vb included in the transmitting packet is located within a tolerance having a preset lower limit value V_{BL} and an upper limit value V_{BH}. When Vb is lower than the V_{BL} or Vb is higher than V_{BH}, it is decided that the battery is abnormal to shift the step to step S53. Then, a variable N showing the number of times of generations of abnormal states is incremented by “1”. Then, the step shifts to step S54 to decide whether or not the variable N is a setting value Ns or larger. When N is smaller than Ns, the process is directly finished to return to the step S51. When N is not smaller than Ns, the abnormality of the battery is determined to shift the step to step S55 and stop the operations of the motor driving circuit 4 and the boosting circuit 2 and finish the process.

When the decided result of the step S52 satisfies V_{BL}≦Vb≦V_{BH}, the step shift to step S56 to decide whether or not the battery current Ib included in the transmitting packet is a prescribed threshold current Ibs or higher. When Ib is not lower than Ibs, it is decided that the battery current is abnormal to shift the step to step S57. Then, an over-current preventing process is performed in which the duty ratio of the pulse width modulation signal to the gate driver circuit 45 is restricted so as to reduce a driving current to the motor 3 to be mounted on a vehicle and the boosted voltage controlling duty ratio D is restricted to return to the step S51.

Further, when the decided result of the step S56 shows that Ib is smaller than Ibs, it is decided that the battery current is normal to shift the step to step S58. In the step S58, input voltage DC_{VI} inputted from the boosting circuit 2 that is detected in the potential dividing circuit 42 is read. Then, the step shifts to step S59 to subtract the input voltage DC_{VI} from output voltage DC_{VO} of the boosting circuit 2 included in the transmitting packet and calculate a deviation Δ DC_{VK} (=DC_{VO}−DC_{VI}) between them. Then, the step shifts to step S60.

In the step S60, the calculated deviation Δ DC_{VK} is divided by wiring resistance R_{L} between the boosting circuit 2 and the motor driving circuit 4 to calculate wiring current I_{CM}. Then, the step shifts to step S61 to decide whether or not the calculated wiring current I_{CM} is a preset setting value I_{CMS} or higher. When I_{CM} is l_{CMS} or higher, it is decided that the motor driving circuit 4 is abnormal, which results from, for instance, the short-circuit of an upper arm of the inverter 43 and the field effect transistor forming the arm to shift the step to step S62. Then, a motor driving circuit abnormality process for stopping the operations of the motor driving circuit 4 and the boosting circuit 2 is performed to return to the step S51.

Further, when the decided result of the step S61 shows I_{CM}<I_{CMS}, it is decided that the wiring current is normal and the abnormality is not generated in the motor driving circuit 4 to shift the step to step S63. Then, an estimated output voltage DC_{VOP} of the boosting circuit 2 is calculated on the basis of the boosted voltage controlling duty ratio D calculated in the above-described boosted voltage control-process. Then, the step shifts to step S64. Then, the output voltage DV_{VO} of the boosting circuit 2 is subtracted from the calculated estimated output voltage DC_{VOP} to calculate a deviation Δ DC. Then, the step shifts to step S65 to decide whether or not the absolute value |Δ DC| of the calculated deviation Δ DC is a preset prescribed value Δ DCs or larger. When |ΔDC| is smaller than ΔDCs, it is decided that the boosting circuit 2 is normal to return to the step S51. When |Δ DC| is not smaller than Δ DCs, it is decided that the boosting circuit 2 is abnormal to shift the step to step S66. Then, the switch 40c for switching the input terminal 40p provided in the motor driving circuit 4 and the battery input terminal 40b is switched to the battery input terminal 40b side and a boosting circuit abnormality process for outputting a driving stop command to the boosting circuit 2 is performed to return to the step S51.

In the processes shown in FIG. 10, the processes of the steps S59 to S61 correspond to the current abnormality detecting unit. The processes of the steps S63 to S65 correspond to the boosted voltage abnormality detecting unit. Further, the communication unit is formed by the communication line 5 and the communication control circuits 30 and 51.

Now, an operation of the first embodiment will be described below.

It is assumed that a vehicle is stopped. Under this stopping state, when an ignition switch is turned on, an engine is started and a dc electric power is supplied to the motor driving circuit 4 from the battery 1 through the boosting circuit 2. Control power is supplied to the microcomputer 25 of the boosting circuit 2 and the microcomputer 46 of the motor driving circuit 4 so that the microcomputers 25 and 46 begin to perform prescribed processes.

At this time, in the microcomputer 25 of the boosting circuit 2, the boosted voltage controlling duty ratio D is set to “0”% so that the voltage boosting rate α is “1” in an initializing process upon turning on a power. Thus, the field effect transistor FET2 is controlled to be turned off and the field effect transistor FET1 is controlled to be turned on. The battery voltage Vb to be supplied to the input terminals 20p and 20n is directly outputted to the input terminal 20p and 20n and supplied to the motor driving circuit 4 through the wiring.

In the motor driving circuit 4, when the steering force is not transmitted to the steering wheel 6, the steering torque Ts detected in the steering torque sensor 12 is “0”. Accordingly, when the auxiliary steering control process shown in FIG. 6 is performed in the microcomputer 46 in the motor driving circuit 4, the auxiliary steering current value I_{M}* calculated by referring to the auxiliary steering current value calculating map shown in FIG. 7 is “0”. Thus, the current command values Iut, Ivt and Iwt to the motor 3 to be mounted on a vehicle are also “0”. The pulse width modulation signal outputted to the gate drive circuit 45 is turned off. All the field effect transistors FETu, FETu′, FETv, FETv′ and FETw and FETw′ respectively forming the inverter 43 maintain their turning off-states. The motor phase currents Imu, Imv and Imw outputted from the motor output terminals 44u, 44v and 44w are likewise “0”. The motor 3 to be mounted on a vehicle is maintained in a stopping state under which an auxiliary steering force is not generated.

In the stopping state of the motor 3 to be mounted on a vehicle, the rotation detecting signal outputted from the resolver 13 does not change. Accordingly, the motor rotating angle θ_{M} detected in the motor rotating angle detecting circuit 49 has a constant value. When the boosted voltage control process shown in FIG. 8 is performed in the microcomputer 46, the motor rotating speed V_{M} and the motor rotating acceleration α_{M} calculated in the steps S32 and S33 also maintain “0”.

Accordingly, the step shifts to the step S36 via the steps S34 and S35 in the processes of FIG. 8. Then, the boosted voltage controlling duty ratio D is set to “0”% in which the voltage boosting rate α of the boosting circuit 2 is “1”. Subsequently, the step shifts to the step S39 to calculate the estimated input voltage DC_{VIP} of the motor driving circuit 4 on the basis of the boosted voltage controlling duty ratio D(n-1) of a previous time and the battery voltage Vb transmitted from the boosting circuit 2. Here, under an initial state that the microcomputer 46 begins to perform a control, an initial value “0”% is set as the boosted voltage controlling duty ratio D(n-1) of the previous time.

Accordingly, since the boosted voltage controlling duty ratio D is set to “0”% and the voltage boosting rate α of the boosting circuit 2 is set to “1”, the estimated input voltage DC_{VIP} of the motor driving circuit 4 has a value equal to that of the battery voltage Vb. Under this state, since the battery voltage Vb is directly supplied to the input terminals 40p and 40n of the motor driving circuit 4 from the boosting circuit 2 as described above, the input voltage DC_{VI} detected in the potential dividing circuit 42 is the battery voltage Vb. The deviation Δ DC_{VI} calculated in the step S41 is also “0” and the corrected duty ratio value Δ D calculated in the step S42 is likewise “0”. Therefore, the boosted voltage controlling duty ratio D of “0”% calculated in the step S36 is directly converted to serial data to form the, transmitting packet including the serial data. The transmitting packet is transmitted to the boosting circuit 2 through the communication line 5.

Thus, in the boosted voltage control process shown in FIG. 4, when the boosting circuit 2 receives the transmitting packet transmitted from the motor driving circuit 4, the step shifts to the step S12 to convert the received boosted voltage controlling duty ratio D to the pulse width modulation signal and outputs the pulse width modulation signal to the gate drive circuit 24. Thus, a state in which the field effect transistor FET1 is controlled to be turned on and the field effect transistor FET2 is controlled to be turned off is kept to maintain the voltage boosting rate α to “1”.

While the steering force is not transmitted to the steering wheel 6, when a driver steers the steering wheel 6 in a desired direction, what is called a stationary swing, the torque detecting signal is outputted from the steering torque sensor 12 in response thereto and the steering torque Ts is inputted to the microcomputer 46 from the steering torque detecting circuit 48 in accordance therewith.

In the auxiliary steering force control process shown in FIG. 6, the microcomputer 46 calculates the auxiliary steering current value I_{M}* for generating the auxiliary steering torque corresponding to the steering torque Ts in the motor 3 to be mounted on a vehicle. The current command values Iut, Ivt and Iwt of the respective phases of the motor 3 to be mounted on a vehicle are calculated on the basis of the auxiliary steering current value I_{M}*. The control elements of the inverter 43 are respectively controlled to be driven on the basis of the current command values Iut, Ivt and Iwt of the phases, respectively.

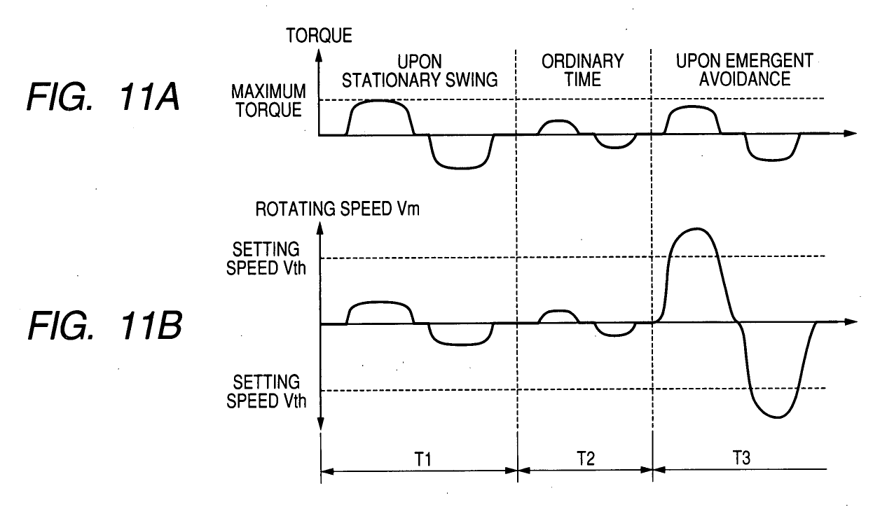

Therefore, as shown in a section T1 in FIG. 11A, a large auxiliary steering torque required for the motor 3 to be mounted on a vehicle is generated. At this time, the motor rotating speed V_{M} of the motor 3 to be mounted on a vehicle is relatively low as shown in the section T1 in FIG. 11B. The motor rotating speed V_{M} is not the rotating speed threshold value V_{MS} or higher and the motor rotating acceleration αM is not the setting value αMS or higher. Accordingly, the step shifts to the step S36 in the boosted voltage control process shown in FIG. B to maintain the state in which the boosted voltage controlling duty ratio D is set to “0”%.

The vehicle is started from its stopping state to be brought to a travelling state. In an ordinary steering state in which the steering wheel 6 is steered under this state, as the vehicle speed increases, a necessary auxiliary steering torque decreases. Accordingly, the steering torque transmitted to the steering wheel 6 has likewise a small value. The steering torque is detected in the steering torque sensor 12 and inputted to the microcomputer 46. As a result, the auxiliary steering current value I_{M}* also has a small value. The auxiliary steering torque generated in the motor 3 to be mounted on a vehicle is smaller than the auxiliary steering torque upon stationary swing as shown in a section T2 in FIG. 11A. The motor rotating speed V_{M} has a smaller value as shown in the section T2 in FIG. 11B. Thus, the step is shifted to the step S36 via the steps S34 and S35 in the processes shown in FIG. 8 to maintain the boosted voltage controlling duty ratio D to “0”%.

As described above, while the voltage boosting rate α of the boosting circuit 2 is set to “1”, that is, while the output voltage DC_{VO} of the boosting circuit 2 is set to the battery voltage Vb, a voltage drop is generated due to the wiring resistance between the boosting circuit 2 and the motor driving circuit 4 in accordance with the increase of the current supplied between them.

However, in the above-described embodiment, in the boosted voltage control process of FIG. 8 performed by the microcomputer 46, the voltage boosting rate α of the boosting circuit 2 is calculated on the basis of the boosted voltage controlling duty ratio D(n-1) of the previous time. The voltage boosting rate α is multiplied by the rated battery voltage Vb* of the battery 1 to calculate the necessary input voltage DC_{VIP} required in the motor driving circuit 4 (step S39). The current input voltage DC_{VI} is subtracted from the calculated necessary input voltage DC_{VIP} to calculate the corrected voltage value Δ DC_{VI} corresponding to the voltage drop due to the wiring resistance (step S41).

Then, the duty ratio corrected value Δ D corresponding to the calculated corrected voltage value Δ DC_{VI} is calculated (step S42). A value obtained by correcting the boosted voltage controlling duty ratio D calculated in the step S36 by the calculated duty ratio corrected value Δ D is calculated as a boosted voltage controlling duty ratio D (step S43). This boosted voltage controlling duty ratio D is stored in the transmitting packet and transmitted to the microcomputer 25 of the boosting circuit 2.

Thus, the pulse width modulation signal is formed so that the voltage boosting rate α for correcting the voltage drop due to the wiring resistance is obtained in the boosting circuit 2. The pulse width modulation signal is supplied to the gate drive circuit 24 so that the on/off ratio of the field effect transistors FET2 and FET1 is controlled. Accordingly, the output voltage DC_{VO} of the boosting circuit 2 is increased by the voltage drop due to the wiring resistance and the input voltage DC_{VI} required in the motor driving circuit 4 is supplied. Consequently, the voltage drop due to the wiring resistance between the boosting circuit 2 and the motor driving circuit 4 or the fall of the input voltage DC_{VI} applied to the motor driving circuit 4 due to the consumption of electric power by other devices mounted on a vehicle can be assuredly prevented. The motor 3 to be mounted on a vehicle can be controlled to be driven with maximum motor characteristics as shown by a full line in FIG. 12. The maximum motor characteristics are represented by taking a motor rotating speed Vm[min⁻¹] in an axis of abscissa and an output torque [N.m] of the motor 3 to be mounted on a vehicle in an axis of ordinate. A maximum current can be outputted and a maximum torque Tmax can be outputted until the motor rotating speed V_{M} reaches a setting rotating speed V_{MS} from “0”.

In this connection, when the voltage drop is not compensated in the boosted voltage control process, assuming that the wiring resistance between the boosting circuit 2 and the motor driving circuit 4 is 20 mΩ, the current supplied from the battery 1 increases. Thus, as shown in FIG. 13, the voltage drop due to the wiring resistance is generated. When the current value reaches 80 A, the voltage drop is 2V and the input voltage DC_{VI} applied to the motor driving circuit 4 falls to 10V. In the maximum motor characteristics of the motor 3 to be mounted on a vehicle, owing to the influence of the voltage drop, the current value increases and the voltage drop increases with the increase of the motor rotating speed V_{M} as shown by a broken line in FIG. 12, so that the output torque is gradually lowered. In a hatched area in FIG. 12, the maximum motor characteristics cannot be exhibited and auxiliary steering control characteristics are deteriorated.

However, in the above-described embodiment, the voltage drop of the input voltage DC_{VI} of the motor driving circuit 4 generated due to the wiring resistance is compensated in the boosted voltage control process of the microcomputer 46 in the motor driving circuit 4 as described above. Accordingly, the maximum motor characteristics can be always exhibited and an optimum auxiliary steering control can be carried out.

On the other hand, under a travelling state, when an emergent avoiding operation such as steering leftward is carried out owing to an interruption from other traffic lane or the protruding drive of an opposed vehicle exceeding a center line of an opposed traffic lane, the steering torque transmitted to the steering wheel 6 is larger than the steering torque at the ordinary time and smaller than that upon stationary swing as shown by a section T3 in FIG. 11A. However, the motor rotating speed V_{M} of the motor 3 to be mounted on a vehicle increases in a positive direction to be the motor rotating speed threshold value V_{MS} or higher as shown by the section T3 in FIG. 11B.

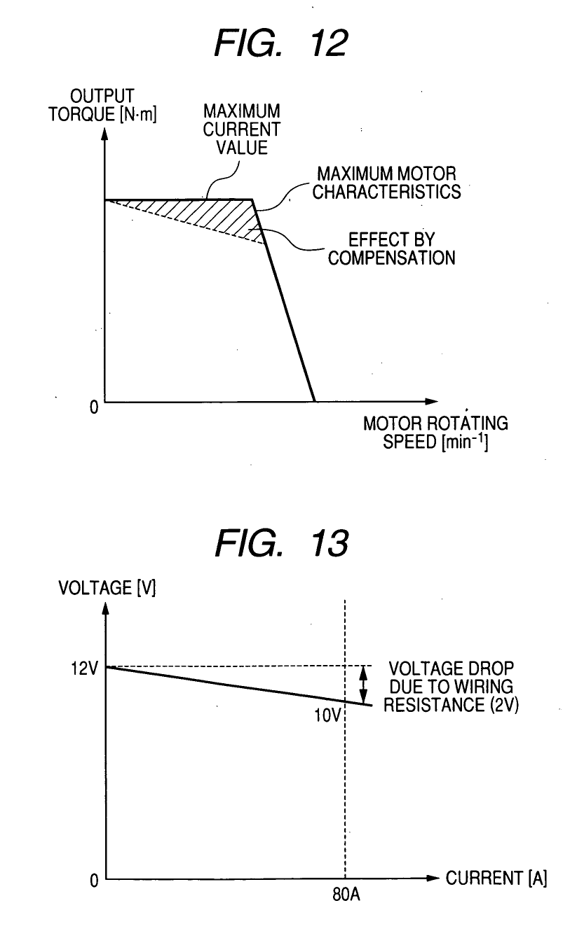

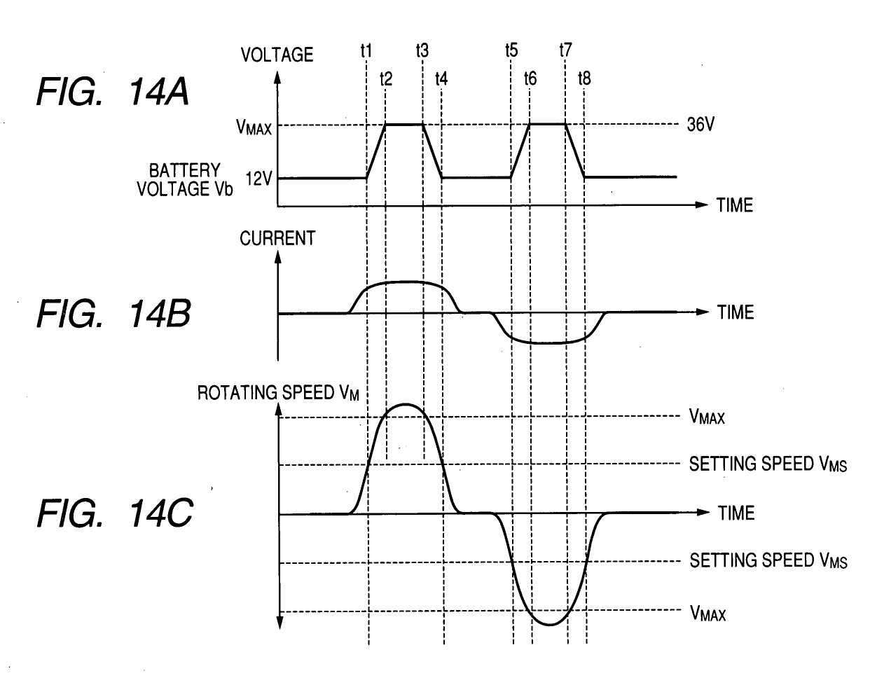

In the emergent avoiding operation, as shown in FIG. 14C, when the motor rotating speed V_{M} of the motor 3 to be mounted on a vehicle reaches the setting speed (rotating speed threshold value) V_{MS} or higher at a time t1, the step S34 shifts to the step S38 in the boosted voltage control process in FIG. 8 to refer to the duty ratio calculating control map shown in FIG. 9 and calculate the boosted voltage controlling duty ratio D larger than “0”% corresponding to the motor rotating speed V_{M}. At this time, when it is assumed that the deviation Δ DC_{VI} between the estimated input voltage DC_{VIP} calculated on the basis of the boosted voltage controlling duty ratio D(n-1) of the previous time and the input voltage DC_{VI} detected in the potential dividing circuit 42 of the motor driving circuit 4 is “0”, the boosted voltage controlling duty ratio D calculated in the step S38 is converted to the serial data and then stored in the transmitting packet and the transmitting packet is transmitted to the boosting circuit 2 through the communication line 5.

Accordingly, in the boosting circuit 2, when the transmitting packet transmitted from the motor driving circuit 4 is received, the pulse width modulation signal corresponding to the boosted voltage controlling duty ratio D included in the transmitting packet is outputted to the gate drive circuit 24. Thus, the field effect transistors FET2 and FET1 are controlled to be turned on and off in accordance with the duty ratio of the pulse width modulation signal. Energy is accumulated in the reactor 23 in a section in which the field effect transistor FET2 is turned on. The accumulated energy is outputted to the output terminal 22p in a section in which the field effect transistor FET1 is turned on. Thus, the voltage boosting rate α of the boosting circuit 2 is increased more than “1”. The output voltage DC_{VO} outputted from the output terminal 22p is increased as shown in FIG. 14A, as the motor rotating speed V_{M} is higher than the setting speed V_{MS}.

After that, when the motor rotating speed V_{M} is more increased to reach the setting speed V_{MSH} at a time t2 at which the boosted voltage controlling duty ratio D calculated in the microcomputer 46 reaches an upper limit duty ratio D_{MAX}, the output voltage DC_{VO} of the boosting circuit 2 is 36 v three times as high as the battery voltage Vb. Subsequently, even when the motor rotating speed V_{M} exceeds the setting speed V_{MSH}, the boosted voltage controlling duty ratio D is limited by the upper limit duty ratio D_{MAX}. Thus, the voltage boosting rate α of the boosting circuit 2 is maintained to “3” and the output voltage DC_{VO} maintains a state three times as high as the battery voltage Vb. Then, at a time t3, when the motor rotating speed V_{M} is lower than the setting speed V_{MSH}, the boosted voltage controlling duty ratio D calculated in the microcomputer 46 is lower than the upper limit duty ratio D_{MAX} in accordance with the fall of the motor rotating speed V_{M}, so that the output voltage DC_{VO} of the boosting circuit 2 decreases. At a time t4, when the motor rotating speed V_{M} is lower than the setting speed V_{MS}, the step shifts to the step S36 via the step S35 from the step 34 in the processes in FIG. 8 performed in the microcomputer 46 to reset the boosted voltage controlling duty ratio D to “0”%. The output voltage DC_{VO} of the boosting circuit 2 is reset to the battery voltage Vb in accordance therewith. After that, when a steering state is held by steering the steering wheel leftward, the motor rotating speed V_{M} is “0”.

Subsequently, at a time t5, when the vehicle comes close to a guard rail or the like so that the steering wheel 6 is returned to a steering neutral position side from a leftward steered state by a quick steering operation, the motor rotating speed V_{M} is increased in a negative direction. At a time t6, when the rotating speed exceeds the setting speed V_{MS}, the boosted voltage controlling duty ratio D begins to increase from “0”%. Thus, the voltage boosting rate α of the boosting circuit 2 increases from, “1” and the output voltage DC_{VO} of the boosting circuit 2 increases from the battery voltage Vb as shown in FIG. 14A. Then, at a time t7, when the motor rotating speed V_{M} reaches the setting rotating speed V_{MSH}, the boosted voltage controlling duty ratio D reaches the upper limit duty ratio D_{MAX}. Thus, the output voltage DC_{VO} of the boosting circuit 2 becomes three times as high as the battery voltage Vb. After that, at the time t7, when the rotating speed V_{M} is lower than the setting rotating speed V_{MSH}, the boosted voltage controlling duty ratio D is lower than the upper limit duty ratio D_{MAX} in accordance with the decrease of the motor rotating speed V_{M}. Thus, the output voltage DC_{VO} of the boosting circuit 2 decreases. At a time t8, when the rotating speed V_{M} is lower than the setting rotating speed V_{MS}, the boosted voltage controlling duty ratio D is set to “0”% and the output voltage DC_{VO} of the boosting circuit 2 is reset to the battery voltage Vb.

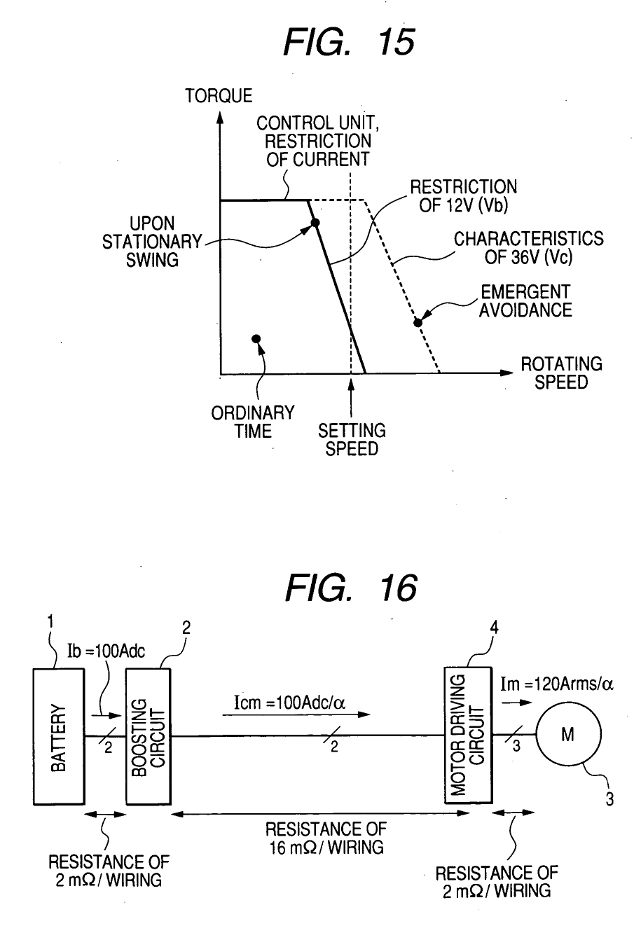

In such a way, upon steering for a voiding an emergency, the input voltage DC_{VI} supplied to the motor driving circuit 4 is raised within a range three times as high as the battery voltage Vb. Accordingly, motor characteristics showing the relation of the rotating speed of the motor 3 to be mounted on a vehicle and the output torque shift to a characteristic line restricted by a charging voltage Vc of 36 V shown by a dotted line from a state restricted by a characteristic line limited by the battery voltage Vb of 12V shown by a full line in FIG. 15. Upon restricted by the same current, a larger output (current X voltage) can be outputted. Even when the rotating speed of the motor 3 to be mounted on a vehicle is high, an insufficient auxiliary steering torque can be avoided.

Further, in the above-described embodiment, the boosting circuit 2 is disposed in the vicinity of the battery 1. The motor driving circuit 4 is disposed in the vicinity of the motor 3 to be mounted on a vehicle. As shown in FIG. 16, assuming that the resistance of the wiring between the battery 1 and the motor 3 to be mounted on a vehicle is 20 mΩ/wiring, an explanation of wiring loss is given to an example that the boosting circuit 2 is arranged at a position of 1:9 of a distance between the battery 1 and the motor 3 to be mounted on a vehicle near the battery 1 and the motor driving circuit 4 is arranged at a position of 9:1 of the distance between the battery 1 and the motor 3 to be mounted on a vehicle near the motor 3 to be mounted on a vehicle.

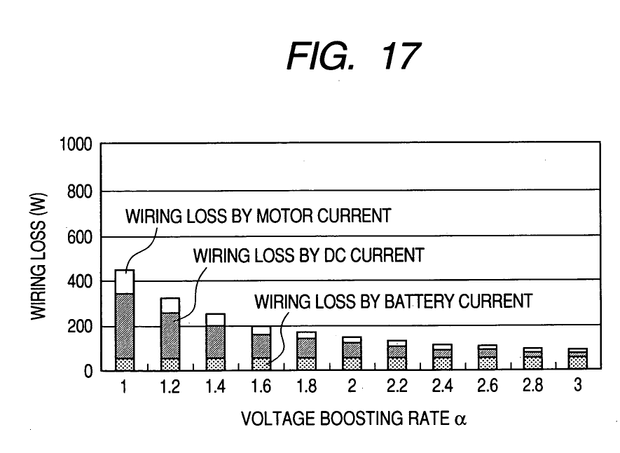

Here, when the on/off ratio of the field effect transistors FET2 and FET1 of the boosting circuit 2, that is, the ratio of the output voltage DC_{VO} of the boosting circuit 2 and the battery voltage Vb that changes depending on the boosted voltage controlling duty ratio D is the voltage boosting rate α (=DC_{VO}/Vb), if the battery current Ib is, for instance, 100 Adc, and the voltage boosting rate α is “1”, it is assumed that the motor rated current Im is 120 Arms and a voltage specification in the motor 3 to be mounted on a vehicle is optimized and set depending on the voltage boosting rate α, the wiring loss relative to the voltage boosting rate α is shown in FIG. 17.

In FIG. 17, the wiring loss by the battery current Ib is obtained as a wiring resistance value×(battery current Ib)²×the number of wiring (two). The wiring loss by the direct current Idc of a direct current part between the boosting circuit 2 and the motor driving circuit 4 is obtained as a wiring resistance value×(DC current Idc/the voltage boosting rate α)²×the number of wiring (two). Further, the wiring loss by the motor current Im is obtained as a wiring resistance value×(motor current Im/the voltage boosting rate α)²×the number of wiring (three).

As apparent from FIG. 17, in the above-described embodiment, assuming that the voltage is boosted, when the motor 3 to be mounted on a vehicle formed with the brush-less motor is designed with a specification of high voltage, the direct current Idc and the motor current Imu to Imw can be reduced in accordance with the voltage boosting rate α. When the voltage is boosted by the structure of the present invention, the wiring loss can be more greatly reduced than that of the related art. The wiring loss can be reduced, which means that the output of the motor 3 to be mounted on a vehicle composed of the brush-less motor can be increased in the limited output of the battery.

The reducing effect of the wiring loss is apparently higher than that of the usual example shown in FIG. 20 in which the controller is disposed in the vicinity of the motor to be mounted on a vehicle, as described in the part of “Problems that the Invention is to Solve”. As compared with an example shown in FIG. 22 in which a controller is disposed in the battery, the reducing effect of the wiring loss can be exhibited with a small voltage boosting rate α.

As described above, the boosting circuit 2 is disposed in the vicinity of the battery and the motor driving circuit 4 is disposed in the motor to be mounted on the vehicle. Thus, a communication distance between the boosting circuit 2 and the motor driving circuit 4 is lengthened. However, the data communication between them is performed by a digital communication with the form of serial data, so that the influence of noise is hardly received and an accurate data communication can be carried out. Further, since the motor driving circuit 4, the motor 3 to be mounted on a vehicle and the steering torque sensor 12 are close to each other, wiring between them is short so that the influence of noise is hardly received.

Further, the microcomputer 46 of the motor driving circuit 4 performs the abnormality detecting process shown in FIG. 10. When the motor driving circuit receives the transmitting packet including the serial data of the battery voltage Vb as the input voltage, the battery current Ib and the output voltage DC_{VO} from the boosting circuit 2, the microcomputer initially decides whether or not the battery voltage Vb is located within a normal range of the lower limit value V_{BL} and the upper limit value V_{BH}. When the battery voltage Vb exceeds the tolerance, the microcomputer decides that there is a possibility that the battery is abnormal to increment the variable N. When the variable N is not smaller than the preset setting value Ns, the microcomputer decides that the battery is abnormal to perform a driving stop process for stopping the drive of the motor driving circuit 4 and the boosting circuit 2. Thus, a consumed power can be reduced when the battery voltage abnormally decreases and the damage of a circuit can be prevented when the battery voltage abnormally increases.

Further, when the battery current Ib is not smaller than the setting current Ibs, the microcomputer decides that the battery 1 is in an over-current state to shift the step to the step S57. The microcomputer restricts the duty ratio of the pulse width modulation signal to the gate drive circuit 45 so as to reduce the motor phase current Imu to Imw supplied to the motor 3 to be mounted on a vehicle from the inverter 43 or performs an over-current preventing process for restricting the boosted voltage controlling duty ratio D.

Further, the microcomputer calculates the deviation Δ DC_{VK} between the output voltage DC_{VO} of the boosting circuit 2 and the input voltage DC_{VI} of the motor driving circuit 4 and calculates the wiring current I_{CM}. by dividing the deviation Δ DC_{VK} by the wiring resistance R_{L}. When the calculated wiring current I_{CM.} is not smaller than the setting value I_{CMS}, the microcomputer decides that the motor driving circuit 4 is abnormal due to the short-circuit of the field effect transistor forming the upper arm and the lower arm of the inverter 43 to perform a motor driving circuit abnormality process for stopping the drive of the motor driving circuit 4 and the boosting circuit 2. In the motor driving circuit abnormality process, the output voltage DC_{VO} of the boosting circuit 2 and the input voltage DC_{VI} of the motor driving circuit 4 are merely detected so that the abnormality of the motor driving circuit 4 due to the over-current can be detected without providing a shunt resistance for detecting an abnormal current in the motor driving circuit 4.

Still further, the microcomputer calculates the estimated output voltage DC_{VOP} of the boosting circuit 2 on the basis of the boosted voltage controlling duty ratio D. When the absolute value |Δ DC| of the deviation Δ DC obtained by subtracting the actual output voltage DC_{VO} of the boosting circuit 2 from the calculated estimated output voltage DC_{VOP} is not smaller than the setting value Δ DCs, the microcomputer decides that the abnormality is generated in the boosting circuit 2 to output the driving stop command to the boosting circuit 2 and stop the drive of the boosting circuit 2. The selecting switch 40c is switched to the battery terminal 40b side from the input terminal 40p side to operate the motor driving circuit 4 in accordance with the battery voltage Vb of the battery 1. Thus, the auxiliary steering force can be generated in the motor 3 to be mounted on a vehicle. A steering performance equal to that of the ordinary electric power steering device having no boosting circuit can be ensured and a hard steering operation can be assuredly avoided.

Further, in the above embodiment, since the power circuit 41 of the motor driving circuit 4 is connected to the battery input terminal 40b connected to the anode side terminal of the battery 1, even when the operation of the boosting circuit 2 is disabled, the microcomputer 46 of the motor driving circuit 4 can maintain its operating state and can inform other devices of the abnormality of the electric power steering device by the communication unit not illustrated in the drawings.

In the above embodiment, an example is described that the boosted voltage controlling duty ratio D is transmitted to the microcomputer 25 of the boosting circuit 2 from the microcomputer 46 of the motor driving circuit 4. However, the present invention is not limited thereto. In the microcomputer 46, the pulse width modulation (PWM) signal corresponding to the boosted voltage controlling duty ratio D may be generated and the generated pulse width modulation signal may be directly supplied to the gate drive circuit 24 of the boosting circuit 2.

Further, in the above embodiment, an example is described that the boosted voltage control process is performed by the microcomputer 46 provided in the motor driving circuit 4 to determine the boosted voltage controlling duty ratio D. However, the present invention is not limited thereto. The motor rotating angle θ_{M} from the motor driving circuit 4 and the input voltage DC_{VI} of the motor driving circuit 4 may be converted to the serial data and the serial data may be transmitted to the microcomputer 25 of the boosting circuit 2. Then, the boosted voltage control process shown in FIG. 8 and the boosted voltage control process shown in FIG. 4 may be carried out in the microcomputer 25. The abnormality detecting process shown in FIG. 10 may be carried out in the microcomputer 25 of the boosting circuit 2.

Further, in the above-described embodiment, an example is described that the auxiliary steering control process is performed in the microcomputer 46 of the motor driving circuit 4. However, the present invention is not limited thereto. An auxiliary steering controller for controlling an auxiliary steering operation may be separately provided. A motor current command value way be supplied to the microcomputer 46 from the auxiliary steering controller to control the motor to be driven.

Still further, in the above-described embodiment, an example is described that the data communication between the boosting circuit 2 and the motor driving circuit 4 is performed by using a digital communication line. However, the present invention is not limited thereto. An optical communication unit using an optical signal may be applied thereto. In this case, a communication stronger for noise can be carried out.

Still further, in the above embodiment, an example is described that the boosting chopper forming the boosting circuit 2 is formed with the reactor 23 and the two field effect transistors FET1 and FET2. However, the present invention is not limited thereto. A diode may be employed in place of the field effect transistor FET1. Further, an arbitrary boosting circuit such as a DC-DC converter, a switched capacitor, etc. may be employed in place of the boosting chopper.

Further, in the above-described embodiment, an example is described that the motor rotating angle is detected by using the resolver 13. However, the present invention is not limited thereto. A rotating angle sensor using a rotary encoder or a Hall element or the like may be applied thereto.

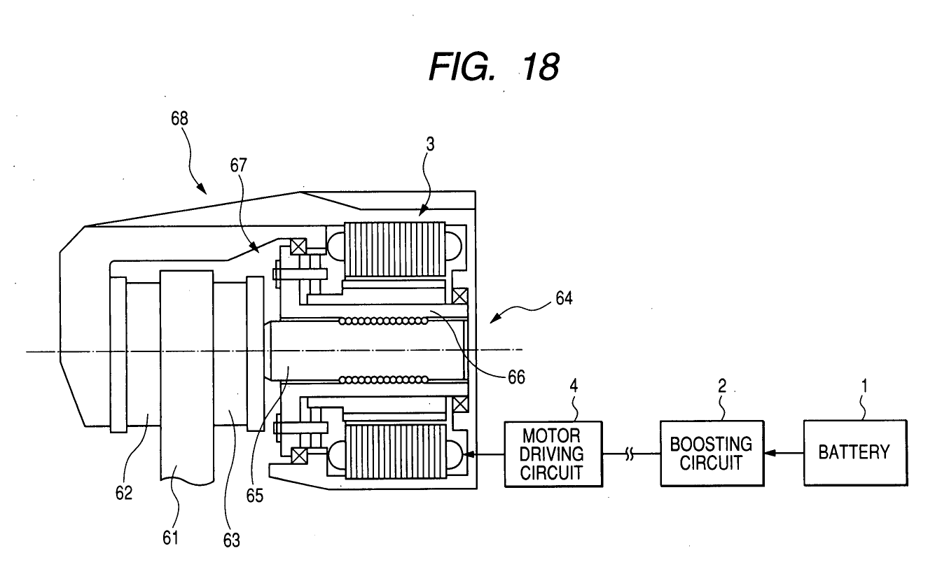

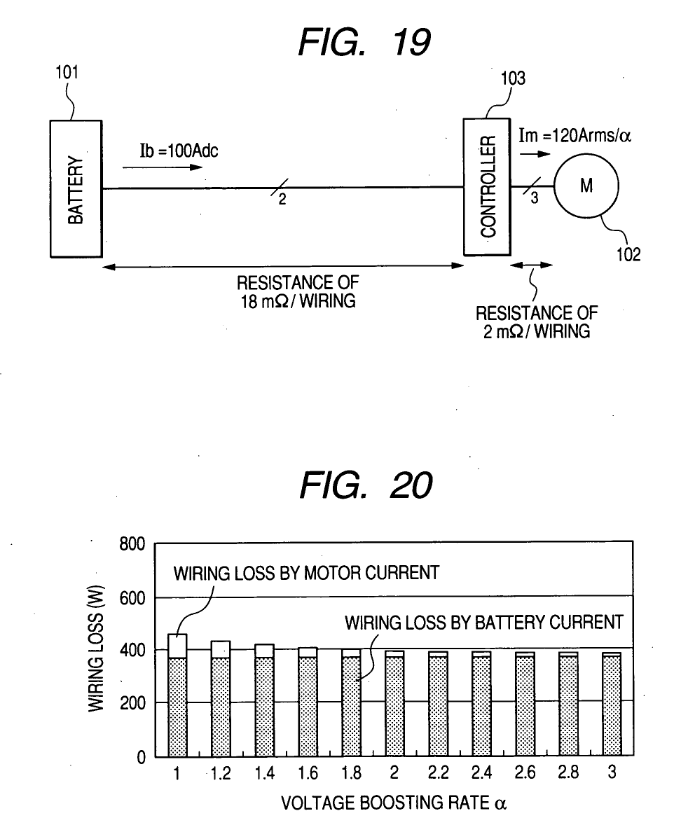

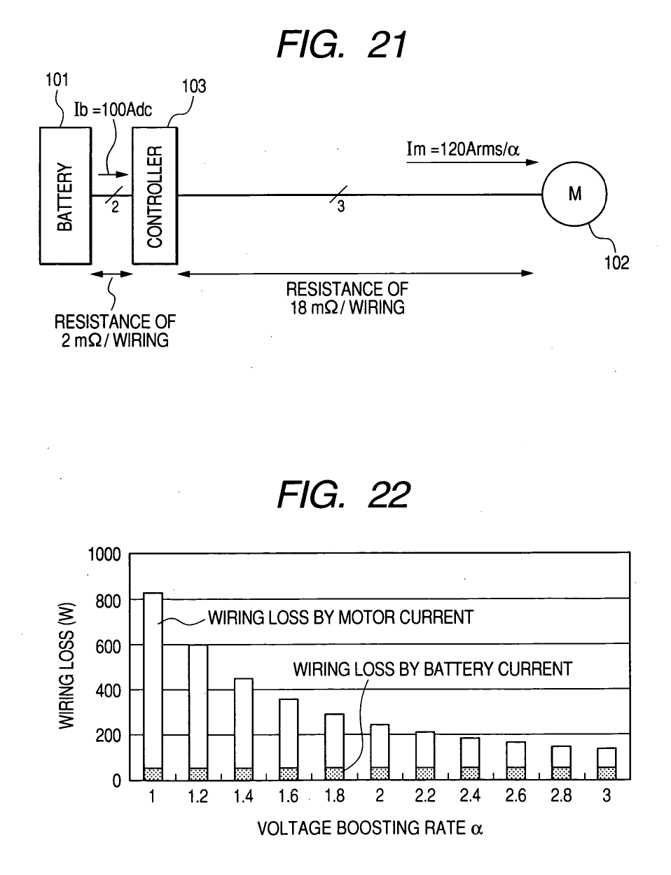

Further, in the above-described embodiment, an example is described that the present invention is applied to the electric power steering device. However, the present invention is not limited thereto. The present invention may be applied to an electric brake device. As the electric brake device, for instance, as shown in FIG. 18, friction pads 62 and 63 are opposed to both the surfaces of a brake disk 61. To one friction pad 63, a ball screw shaft 65 of a ball screw mechanism 64 is connected. A ball nut 66 of the ball screw mechanism 64 has a caliper 68 connected to a motor 3 to be mounted on a vehicle through, for instance, a speed reducing mechanism 67 such as a planetary gear mechanism. The motor 3 to be mounted on the vehicle is controlled to be driven by a motor driving circuit 4 to which a boosted voltage is applied from a boosting circuit 2. Here, the microcomputer 46 of the motor driving circuit 4 performs processes the same as those of FIG. 8 and FIG. 10 except that the microcomputer performs a brake control process for calculating a braking current value on the basis of a quantity of stepping of a brake pedal, a quantity of brake required for a yoke rate control and a traction control instead of the auxiliary steering control process shown in FIG. 6. Besides, the present invention may be applied to other arbitrary motor controller to be mounted on a vehicle.

Still further, in the above-described embodiment, an example is described that the brush-less motor is employed as the motor 3 to be mounted on a vehicle and the brush-less motor is driven by a three-phase alternating current. However, the present invention is not limited thereto. The brush-less motor may be driven by an alternating current of five phases or more. Further, a Dc motor may be used and the DC motor may be driven by an H bridge circuit.

### Second Embodiment

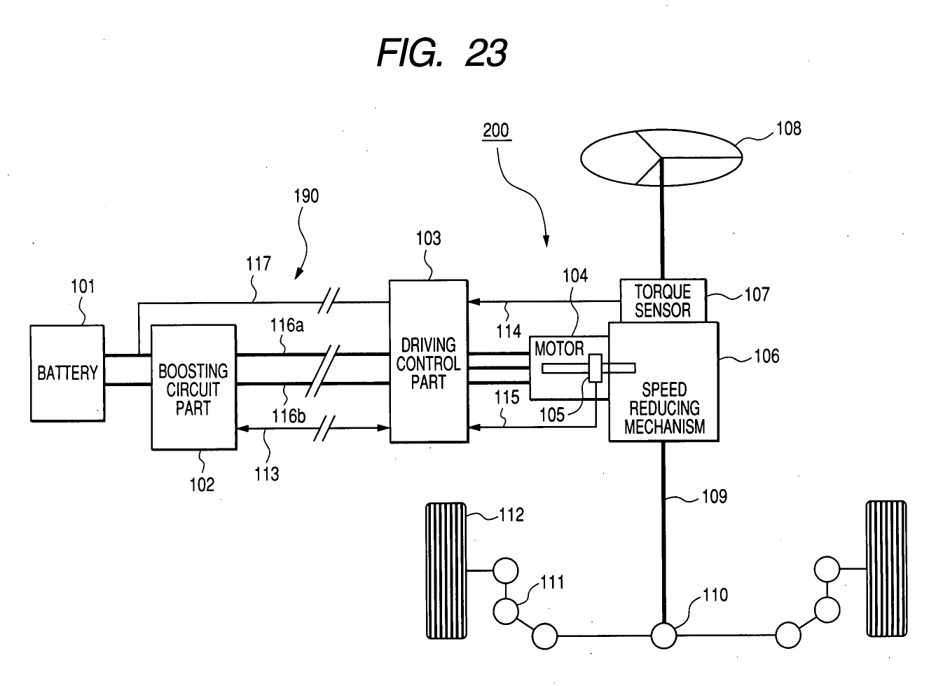

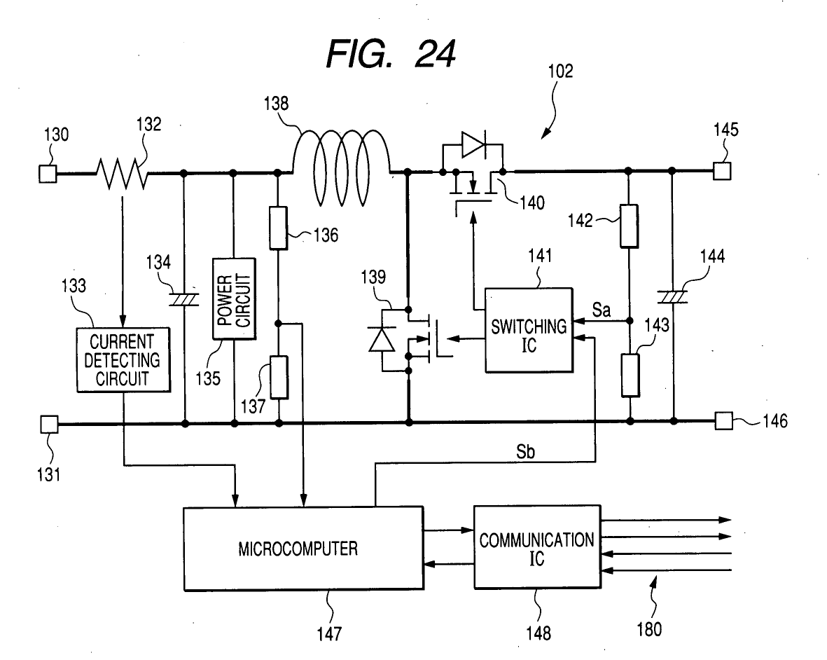

Further, second embodiment that the present invention is applied to an electric power steering device will be described by referring to FIGS. 23 to 29. In FIG. 23 showing the entire structure of a power steering device 200, the torque of a steering shaft 109 having one end fixed to a steering handle 108 disposed in a cabin is transmitted as a force for changing the direction of wheels 112 attached to both the ends of a rack shaft through connecting mechanisms 111 by a rack and pinion mechanism 110. In the steering shaft 109, a three-phase brush-less DC motor 104 for assisting the torque is arranged. The motor 104 is connected to the shaft 109 through a speed reducing mechanism 106.

A boosting-circuit part 102 using a battery 101 as a power source to boost a battery voltage is arranged in the vicinity of the battery 101 so as to be adjacent to or come into close contact with the battery 101. The voltage boosted by the boosting circuit part 102 is supplied to a motor driving control part 103 via wiring 116a and 116b. The motor driving control part 103 is disposed in the vicinity of the brush-less motor 104 to be adjacent to or come into close contact with the motor 104 to PWM control an electric current supplied to the motor 104. To the motor driving control part 103, battery voltage as a control power is supplied through wiring 117 and a signal line 114 of a torque sensor 107 for detecting a torque exerted on the steering shaft 109 or a signal line 115 of a resolver 105 for detecting a rotating position of the motor 104 is connected.

Now, the structure of the boosting circuit part 102 will be described by referring to FIG. 24. Input terminals 130 and 131 of the boosting circuit part 102 are connected to the battery 101. The anode side input terminal 130 is connected to one end of a reactor 138 through a shunt resistance 132. Further, between common nodes of the shunt resistance 132 and the reactor 138 and the cathode side input terminal 131, a condenser 134, a power circuit 135 and a series circuit of potential dividing resistances 136 and 137 are connected in parallel.

Both the ends of the shunt resistance 132 are connected to a current detecting circuit 133 for shifting and amplifying the level of terminal voltage thereof. An output terminal of the current detecting circuit 133 is connected to an analog/digital converting input terminal of a microcomputer 147. The power circuit 135 generates and supplies the operating power of the microcomputer 147, a switching IC141 and a communication IC148. The potential dividing resistances 136 and 137 divide the battery voltage and supply the battery voltage to the analog/digital converting input terminal of the microcomputer 147.

The other end of the reactor 138 is connected to a drain of an FET 139 whose source is connected to the cathode side input terminal 131 and a source of an PET 140. A drain of the FET 140 is connected to an anode side output terminal 145. Between the anode side output terminal 145 and a cathode side output terminal 146, a series circuit of potential dividing resistances 142 and 143 and a condenser 144 are connected.

To an input terminal of the switching IC141, a signal sa as a divided potential by the potential dividing resistances 142 and 143 and a signal Sb outputted from the microcomputer 147 are supplied. Further, an output terminal for outputting a PWM signal by the switching IC141 is connected to gate terminals of the FETs 139 and 140 through a gate drive circuit that is not shown in the drawing. Input and output terminals for a communication of the microcomputer 147 are connected to a communication line 113 through the communication IC148.

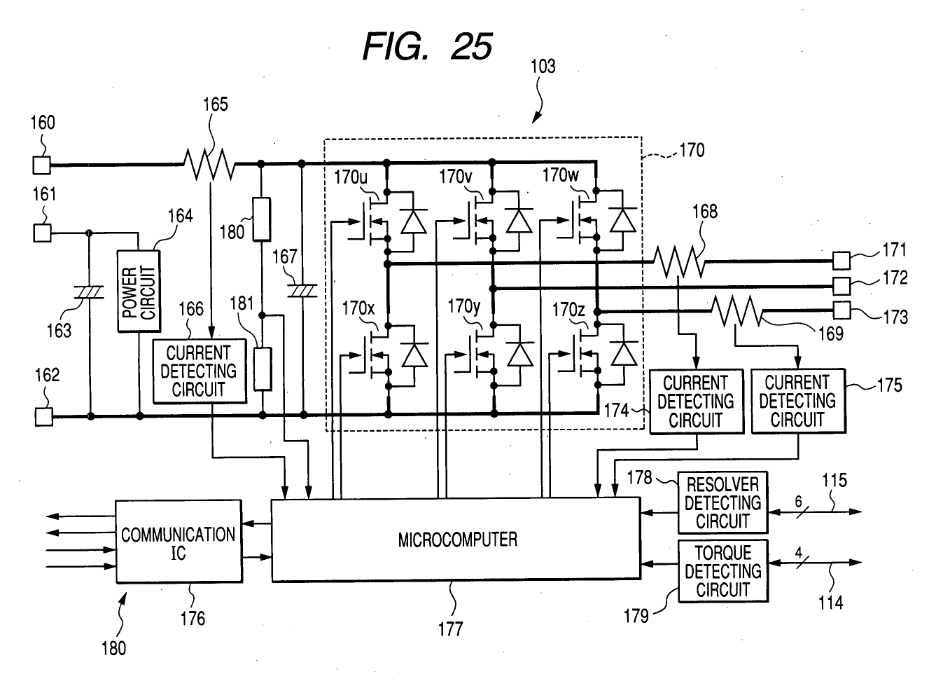

Now, the structure of the driving control part 103 will be described by referring to FIG. 25. Between an input terminal 161 directly connected to an anode side of the battery 101 through the wiring 117 and a cathode side input terminal 162, a condenser 163 and a power circuit 164 for supplying a power to a microcomputer 177 are connected. An anode side input terminal 160 connected to the anode side output terminal 145 of the boosting circuit part 102 through the wiring 116a is connected to a inverter main circuit 170 through a shunt resistance 165.

The cathode side input terminal 162 is connected to the cathode side output terminal 146 of the boosting circuit part 102 through the wiring 116b. Between the inverter main circuit 170 side of the shunt resistance 165 and the cathode side input terminal 162, a series circuit of potential dividing resistances 180 and 181 and a condenser 167 are connected in parallel with each other. The inverter main circuit 170 is formed by connecting three-phase bridges including six FETs 170u to 170z. The U-phase and the W-phase of the output points of arms respectively forming the inverter main circuit 170 are respectively connected to output terminals 171 and 173 through shunt resistances 168 and 169. A V-phase is directly connected to an output terminal 172.

The output terminals 171, 172 and 173 of the inverter main circuit 170 are respectively connected to the windings of phases of the brush-less motor 104. The potential dividing resistances 180 and 181 divide DC voltage applied between the input terminals 160 and 162 and supply the DC voltage to an analog/digital converting input terminal of the microcomputer 177. The shunt resistances 165, 168 and 169 are connected to current detecting circuits 166, 174 and 175 for shifting and amplifying the level of voltage at both the ends thereof. The output terminals of the current detecting circuits 166, 174 and 175 are connected to the analog/digital converting input terminal of the microcomputer 177. The microcomputer 177 outputs an on/off signal (PWM signal) respectively to the FETs 170u to 170z of the inverter main circuit 170 through a gate drive circuit that is not shown in the drawing. Communication input and output terminals of the microcomputer 177 are connected to the communication line 113 through a communication IC176.

An input terminal of a resolver detecting circuit 178 is connected to the resolver 105 disposed in the brush-less motor 104 through the wiring 115. An output terminal of the resolver detecting circuit 178 is connected to an input terminal of the microcomputer 177. An input terminal of a torque detecting circuit 179 is connected to the torque sensor 107 disposed in the steering shaft through the wiring 114. An output terminal of the torque detecting circuit 179 is connected to the analog/digital converting input terminal of the microcomputer 177.

The microcomputer 147 and the communication IC148 of the boosting circuit part 102, the communication line 113 and the microcomputer 177 and the communication IC176 of the motor driving control part 103 form a communication unit 180. A communication performed between the communication ICs148 and 176 is, for instance, a serial communication such as RS-485. The boosting circuit part 102 and the motor driving control part 103 form a controller 190 for a motor to be mounted on a vehicle.

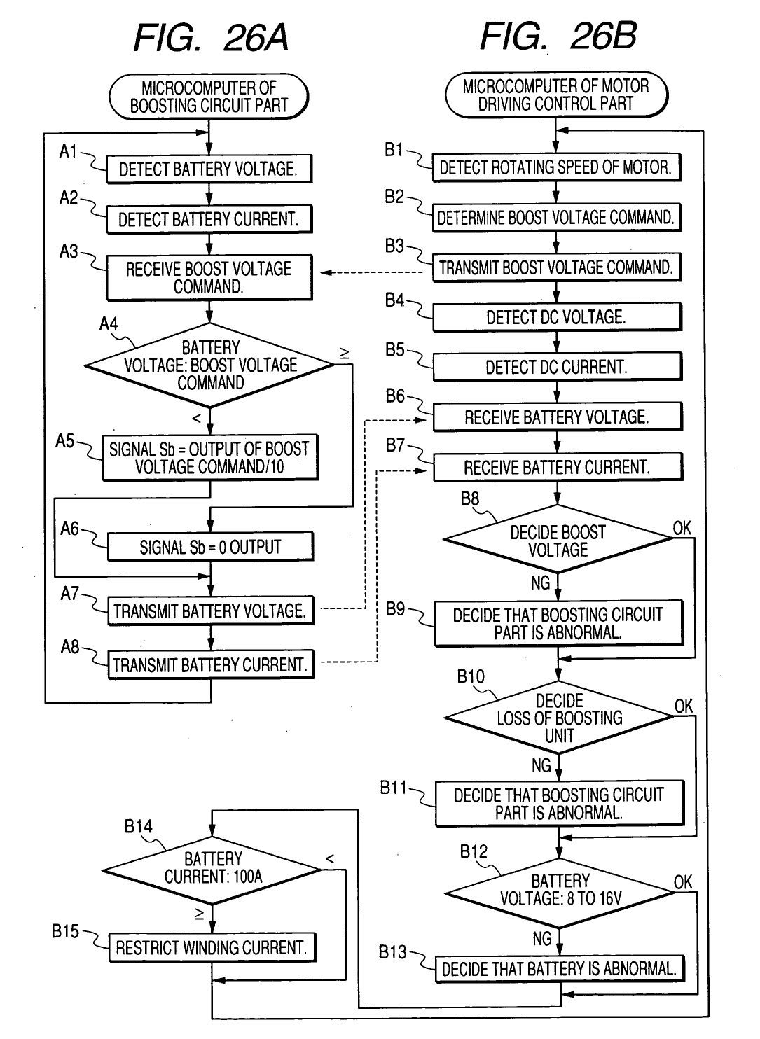

Now, an operation of this embodiment will be described with reference to FIGS. 26 to 29. When a battery power is turned on, the power is supplied to the input terminal 161 of the motor driving control part 103 through the wiring 117. Then, the operating power of the microcomputer 177, the current detecting circuits 166, 174 and 175, the communication IC176, the resolver detecting circuit 178 and the torque detecting circuit 179 is generated and supplied by the power circuit 164. Thus, these members begin to operate.

The current detecting circuits 166, 174 and 175 form signals amplified by 20 times as high as for instance, 2.5V as a reference so that the terminal voltages of the shunt resistances 165, 168 and 169 to which the current detecting circuits 166, 174 and 175 are respectively connected can be inputted to the microcomputer 177. The potential dividing resistances 180 and 181 form a signal obtained by dividing the DC voltage applied to the anode side input terminal 160 to, for instance, 1/10. The microcomputer 177 cyclically analog/digital converts the signals to detect the input DC voltage of the motor driving control part 103, the winding current of the brush-less motor 104 and the input current of the motor deriving control part 103.

The resolver detecting circuit 178 supplies an exciting signal to the resolver 105 and receives cosine and sine signals outputted by the resolver 105 and resolver/digital converts the signals to supply digital signals of 12 bits to the microcomputer 177. The microcomputer 177 refers to the digital signals outputted by the resolver detecting circuit 178 to detect the rotating position of the brush-less motor 104. Further, the torque detecting circuit 179 differentially amplifies a signal outputted by the torque sensor 107 and supplies the signal to the microcomputer 177 as a torque signal. The microcomputer 177 cyclically analog/digital converts the torque signal to detect the torque exerted on the steering shaft 109.

Further, the microcomputer 177 feedback-controls motor current to form a current command on the basis of the detected rotating position of the motor 104 and torque information and compares the current command with the detected motor current to determine an output voltage. The determined output voltage is converted to a PWM signal in the microcomputer 177 and the PWM signal is outputted as a gate signal to the FFTs 170u to 170z respectively. The FETs 170u to 170z are respectively turned on and off in accordance with the supplied gate signal to supply PWM voltage respectively to the phases of the brush-less motor. Thus, the current control of the brush-less motor 104 corresponding to the torque obtained in the torque sensor 107 is performed.

FIGS. 26A and 26B are flowcharts respectively mainly showing the contents of processes of a communication performed between the microcomputer 147 of the boosting circuit part 102 side and the microcomputer 177 of the driving control part 103 side. The microcomputer 177 includes a unit for detecting the rotating speed of the brush-less motor 104 from the change of the detected rotating position (step B1). The microcomputer 177 determines a boost voltage command corresponding to the rotating speed to the boosting circuit part 102 (step B2).

Specifically, when the rotating speed of the brush-less motor 104 is a prescribed value or lower, the microcomputer 177 determines a boosted voltage to be zero. When the rotating speed exceeds a prescribed rotating speed, the microcomputer 177 determines a boosted voltage correspondingly to a quantity of excess. For instance, when a driver operates the handle 108 by quickly rotating it, a rotor of the brush-less motor 104 rotates through the steering shaft 109 and the speed reducing mechanism 106. Further, the rotor of the brush-less motor 104 rotates at high speed by the driving control part 103 depending on the torque exerted on the handle 108.

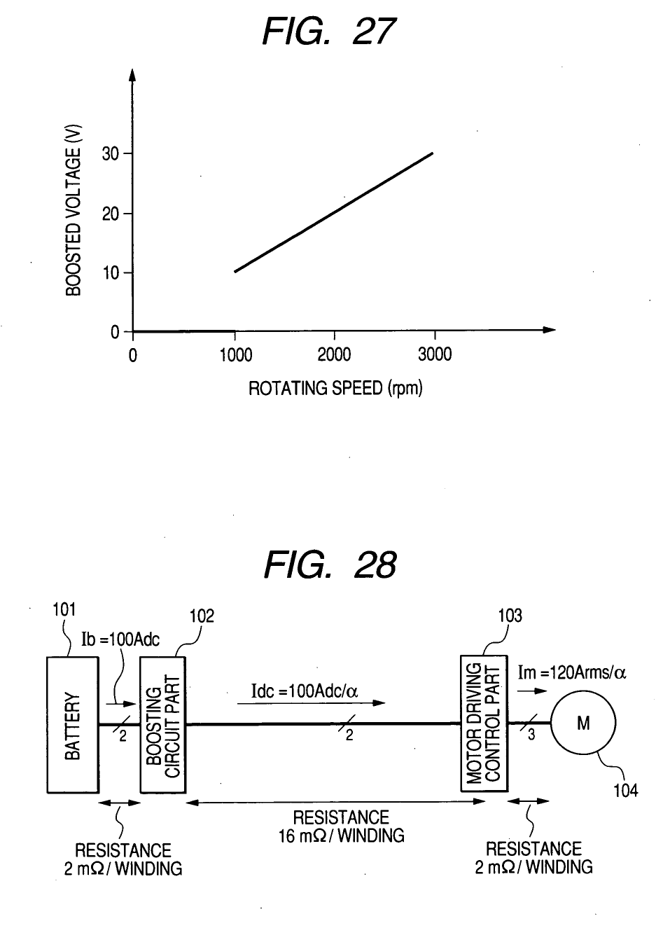

At this time, the microcomputer 177 detects the rotating speed of the rotor of the brush-less motor 104 to immediately determine a boost voltage command. An example of the relation of the rotating speed of the brush-less-motor 104 and the boosted voltage command is shown in FIG. 27. The microcomputer 177 cyclically converts the boost voltage command to serial data and outputs the serial data to a communication output terminal. Thus, the boost voltage command corresponding to the rotating speed is transmitted to the boosting circuit part 102 (step B3). Then, the communication IC176 amplifies the boost voltage command to change to a two-wire differential signal and output the signal to the communication line 113.

On the other hand, in the boosting circuit part 102, when the battery power is turned on, the power is supplied to the microcomputer 147, the switching IC141 and the communication IC148 under the operation of the power circuit 135. The current detecting circuit 133 forms a signal amplified by 20 times as high as, for instance, 2.5V as a reference so that voltage at both the ends of the shunt resistance 132 can be inputted to the microcomputer 147. Further, the potential dividing resistances 136 and 137 divide battery voltage to, for instance 1/10.

The microcomputer 147 cyclically analog-digital converts the output signal of the current detecting circuit 133 and the potential dividing resistances 136 and 137 to detect the battery current and the battery voltage (steps A1 and A2). The microcomputer cyclically converts the battery current and battery voltage to serial data and outputs the serial data to a communication output terminal (steps A7 and A8). The communication IC148 amplifies the serial data to change to a two-wire signal and outputs the signal to the communication line 113.

The microcomputer 147 cyclically receives a serial signal of the communication line 113 through the communication IC148 at the same time so that the microcomputer recognizes the boost voltage command from the motor driving control part 103 (step A3). The microcomputer 147 outputs an analog signal Sb from a digital/analog output terminal in accordance with the boosted voltage command. This relation is set by, for instance, a below-described expression.
Signal Sb≈(boost voltage command)/10

The switching IC141 outputs signals of a high frequency that are alternately turned on and off in the FETs 139 and 140. The ratio of on and off is determined by the signals Sa and Sb as input signals. The signal Sa is formed by dividing the voltage of the condenser 144 to, for instance, 1/10 by the potential dividing resistances 142 and 143. Then, when Sa is smaller than Sb, the switching IC141 operates to increase the on-ratio of the FET139 (off-ratio of the FET140) in accordance with the input signals Sa and Sb. When Sa is larger than Sb, the switching IC141 operates to decrease the on-ratio of the FET139 (off-ratio of the FET140).

When the FET 139 is turned on, electric current is supplied through a path from the reactor 138 to the FET139 to accumulate energy in the reactor 138. Under this state, when the FET139 is turned off and the FET140 is turned on, the energy accumulated in the reactor 138 is discharged through a path from the reactor 138 to the FET140 and to the condenser 144 to raise the terminal voltage of the condenser 144. That is, since the on/off ratio of the FETs 139 and 140 is adjusted in accordance with the signal Sa obtained by dividing the terminal voltage of the condenser 144 and the signal Sb from the microcomputer 147, the terminal voltage of the condenser 144 is controlled by the signal Sb.

Since the signal Sb is determined by the microcomputer 147 on the basis of the boost voltage command transmitted by the driving control part 103, the output voltage of the boosting circuit 102 is controlled by the motor driving control part 103. For instance, it is assumed that the motor driving control part 103 determines the boost voltage command to be 0V on the basis of the rotating speed of the brush-less motor 104. Then, the microcomputer 147 compares the boost voltage command obtained through a communication with the battery voltage (for instance, 12V) (step A4). In this case, the battery voltage is not lower than the boost voltage command, the microcomputer 147 determines the signal Sb to be zero and outputs the signal Sb (step A6). Thus, the switching IC141 turns off the FET139 and turns on the FET140. Accordingly, the boosting circuit part 102 does not perform a voltage boosting operation. Therefore, the battery voltage is directly outputted to the output terminals 145 and 146.

Further, it is assumed that the motor driving control part 103 determines the boost voltage command to be, for instance, 20V on the basis of the rotating speed of the brush-less motor 104. In this case, since the battery voltage is lower than the boost voltage command, the microcomputer 147 determines the signal Sb to be 2V and outputs the signal Sb (step AS). Then, the switching IC141 adjusts the on/off ratio of the FETs 139 and 140 and the boosting circuit part 102 performs a voltage boosting operation so that the voltage boosted to 20V is outputted to the output terminals 145 and 146.

Further, when the motor driving control part 103 determines the boost voltage command to be 10V, since the battery voltage is not lower than the boost voltage command, the microcomputer 147 determines the signal Sb to be zero(step A6). Accordingly, the boosting circuit part 102 does not perform a voltage boosting operation.

Further, the microcomputer 177 of the motor driving, control part 103 has an abnormal operation deciding function of the boosting circuit part 102. The microcomputer 177 analog/digital converts a divided potential by the potential dividing resistances 180 and 181 to detect a DC voltage (step B4) and detect a DC current by the shunt resistance 165 (step B5). Then, the microcomputer 177 compares the boost voltage command transmitted to the boosting circuit part 102 in the step B3 with a value obtained by adding a product of the DC current value and a resistance value of the wiring 116 to the detected DC voltage (step B8) When a difference between them is larger than a prescribed value (“NG”), the microcomputer decides that the boosting circuit part 102 is abnormal (step B9). That is, the steps B8 and B9 correspond to a deciding unit.

Further, the microcomputer 177 receives the battery current value and the battery voltage value transmitted from the boosting circuit part 102 (steps B6 and B7) to calculate an input power of the boosting circuit part 102 on the basis of them. Then, the microcomputer 177 obtains an output power of the boosting circuit part 102 from the DC voltage and the DC current of the motor driving control part 103 to obtain a loss of the boosting circuit part 102 from the difference between them. Then, the loss is compared with a normal value to decide the abnormality of the boosting circuit part 102 (step B10). When the former is higher than the latter (“NG”), the microcomputer 177 decides that the boosting circuit part 102 is abnormal (step B11).

Further, the microcomputer 177 monitors the battery voltage value transmitted form the boosting circuit part 102. For instance, when the battery voltage exceeds 8 to 16V of a normal range (step B12, “NG”), the microcomputer 177 decides that the battery 101 is abnormal (step B13) Further, the microcomputer 177 monitors the battery current value transmitted from the boosting circuit part 102. For instance, when the battery current value is not lower than, for instance, 100A (step B14, “2”), the microcomputer restricts the current supplied to the windings of the motor 104 to prevent the over-current of the battery (step B15).

As described above, according to this embodiment, the driving control part 103 disposed in the vicinity of the motor 104 transmits the boost voltage command to the boosting circuit part 102 through the communication unit 180. The boosting circuit part 102 disposed in the vicinity of the battery 101 performs the voltage boosting operation in accordance with the command to supply the boosted voltage to the motor driving control part 103.

Namely, the motor driving control part 103, the brush-less motor 104 and the torque sensor 107 are adjacently provided so that the wiring 114 and 115 are extremely short. Thus, the influence of noise may be rarely received. Further, a countermeasure for noise is easily made. On the other hand, since the distance between the arrangements of the driving control part 103 and the boosting circuit part 102 is lengthened, the communication line 113 between them is long. However, a communication between them is performed by a digital signal, so that the influence of noise is hardly received.

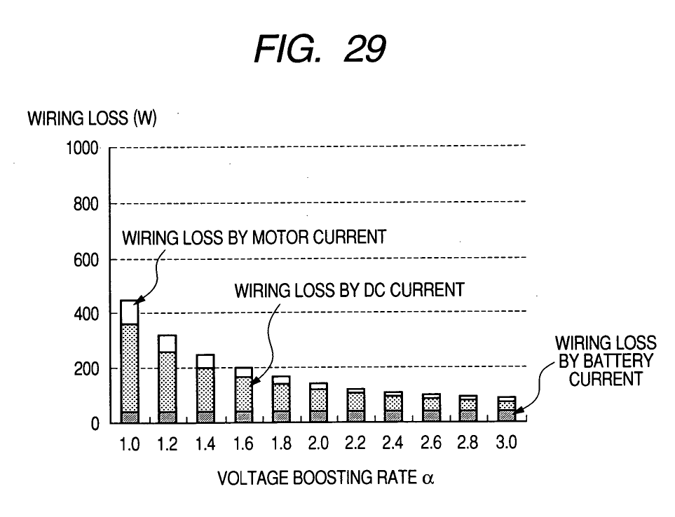

Now, an effect to the wiring loss when the boosting circuit 102 is separated from the driving control part 103 is described by referring to FIGS. 28 and 29. FIG. 28 corresponds to FIG. 32 or FIG. 34 showing the usual example. FIG. 28 shows an example that a driving control part 103 is provided at a position of 9:1 in the vicinity of a motor and a boosting circuit part 102 is provided at a position of 1:9 in the vicinity of a battery 101. Other conditions are the same as those of the usual example.

FIG. 29 shows that, assuming that a voltage is boosted, when a brush-less motor 104 is designed with a specification of high voltage, a DC current and a motor current can be reduced depending on the increase of a voltage boosting rate α, and, when voltage is boosted by using the structure of the present invention, wiring loss can be more reduced than usual. The wiring loss can be reduced, which means that the output of the brush-less motor 104 can be increased in a limited battery output. The reducing effect of the wiring loss is apparently higher than that of the example shown in FIG. 30 in which the usual controller 203 is disposed in the vicinity of the motor. Further, as compared with the example shown in FIG. 32 in which the controller 203 is disposed in the vicinity of the battery, the reducing effect of the wiring loss FIG. 32, the reducing effect of the wiring loss can be recognized under a stall voltage boosting rate.

Further, according to this embodiment, the driving control part 103 decides the abnormality of the boosting circuit part 102 on the basis of a result obtained by comparing the boost voltage command transmitted to the boosting circuit part 102 with the detected boosted voltage. Accordingly, whether or not the boosting circuit part 102 operates properly in accordance with the command can be decided. Further, the boosting circuit part 102 transmits the detected results of the battery voltage and the battery current to the driving control part 103 through the communication unit 180. The driving control part 103 monitors the transmitted battery voltage value to decide the abnormality of the battery 101. Further, the driving control part 103 monitors the transmitted battery current value to restrict the wiring current of the motor 104 as required. Accordingly, the over-current of the battery 101 can be prevented.

Further, the driving control part 103 controls the brush-less motor 104 to be driven. That is, when a DC motor with a brush is used, the number of wiring between the driving circuit and the motor is two. However, when the brush-less motor 104 is used, the number of the wiring is three. According, when the driving control part 103 is provided adjacently to the motor 104 as in this embodiment, even if the number of the wiring is increased, a wiring distance is shortened. Thus, a wiring process can be easily carried out and the increase of a cost can be suppressed.

In addition thereto, in this embodiment, the rotating position of the rotor in the motor 104 is detected by using the resolver 105. Thus, the number of the wiring required between the resolver 105 and the detecting circuit 178 thereof is six. However, since the driving control part 103 is provided adjacently to the motor 104 as described above, the wiring distance between them can be reduced.

Further, the driving control part 103 includes the power circuit 164 for generating a controlling power from the battery voltage. Since the power circuit 164 is not connected to the output line of the boosting circuit part 102 and connected to the wiring 117 directly connected to the anode side power source of the battery 101. Accordingly, when the boosting circuit part 102 cannot be operated, the microcomputer 177 of the driving control part 103 can be operated to inform other devices of the generation of the abnormality in the power steering device 200 by a communication unit not illustrated in the drawing.

The controller 190 for a motor to be on a vehicle is applied to the power steering device 200 that assists the drive of the steering shaft 109 by the output torque of the motor 104. That is, the motor 104 of the power steering device 200 is disposed in the vicinity of the steering shaft 109. To assist the steering power of the driver by driving the motor 104, information such as the rotating position of the steering shaft 109 or the torque acting on the shaft 109 needs to be obtained by using the resolver 105 or the torque sensor 107 or the like. Therefore, the motor 104 is necessarily separated from the battery 101. Further, the wiring of various kinds of sensor signals needs to be pulled around between the driving control part 103 and the motor 104. Consequently, the controller 190 for a motor to be mounted on a vehicle is applied to the power steering device so that various problems caused by the form of the system of the power steering device 200 can be solved. Then, the power steering device 200 with a high output can be constructed.

The present invention is not limited only to the embodiment and the examples described above and in the drawings. Below-described modifications or expansions may be made.

The driving control part 103 is preferably disposed in the vicinity of the motor 104 as near as possible, that is, disposed so as to come into close contact with the motor. Similarly, the boosting circuit 102 is preferably arranged near the battery 101 as much as possible. Further, the driving control part 103 may be formed integrally with the motor 104, and the boosting circuit part 102 maybe formed integrally with the battery 101 respectively, if possible.

As the unit for detecting the rotating position of the rotor, a rotary encoder may be used in place of the resolver 105. Further, a position detecting element such as a Hall IC may be used. A period during which the element outputs a detecting signal may be measured and the period may obtained by a calculation and interpolated.

The process for deciding the abnormality of the boosting circuit part 102 or the battery 101 by the driving control part 103 and the process for restricting the wiring current of the motor 104 may be carried out as required. As the information transferred between the boosting circuit, part 102 and the driving control part 103, necessary information may be suitably selected depending on individual designs.

The power circuit 164 may not be provided in the driving control part 103 and controlling power that is generated in the boosting circuit part 102 may be supplied.

Instead of the brush-less motor 104, other three-phase motor, such as an induction motor may be employed.

The boosting circuit part and the driving control part may respectively independently operate without providing the communication unit. That is, the boosting circuit part may perform a voltage boosting operation with a constantly prescribed voltage boosting rate.

The present invention is not limited to the power steering device 200 and any of devices that controls the motor to be mounted on a vehicle to be driven may be employed.

What is claimed is:

1. A controller for a motor to be mounted on a vehicle comprising:
a boosting unit for raising the voltage of a battery that is disposed near the battery;
a motor driving unit disposed near the motor to be mounted on the vehicle for controlling the motor to be mounted on the vehicle to be driven in accordance with the boosted voltage outputted from the boosting unit; and
a communication unit disposed between the boosting unit and the motor driving unit.

2. The controller for a motor to be mounted on a vehicle according to claim 1, wherein
the motor driving unit includes:
a motor rotating state detecting unit for detecting the rotating state of the motor to be mounted on a vehicle;
a boosted voltage control command determining unit for determining a boosted voltage control command to the boosting unit on the basis of the rotating state of the motor detected by the motor rotating state detecting unit, and
a data transmitting unit for transmitting the boosted voltage control command determined by the boosted voltage control command determining unit to the boosting unit through the communication unit.

3. The controller for a motor to be mounted on a vehicle according to claim 2, wherein
the motor rotating state detecting unit includes:
a rotating speed detecting unit for detecting the rotating speed of the motor to be mounted on a vehicle.

4. The controller for a motor to be mounted on a vehicle according to claim 2, wherein
the motor rotating state detecting unit includes:
a rotating acceleration detecting unit for detecting the rotating acceleration of the motor to be mounted on a vehicle.

5. The controller for a motor to be mounted on a vehicle according to claim 2, wherein
the boosting unit includes:
a boosted voltage control unit for controlling a boosted output voltage in accordance with the boosted voltage control command transmitted from the data transmitting unit of the motor driving unit.

6. The controller for a motor to be mounted on a vehicle according to claim 1, wherein
the boosting unit include:
a boosted output voltage detecting unit for detecting the boosted output voltage, and
a data transmitting unit for transmitting the boosted output voltage detected by the boosted output voltage detecting unit to the motor driving unit through the communication unit.

7. The controller for a motor to be mounted on a vehicle according to claim 6, wherein
the motor driving unit includes:
an applied voltage detecting unit for detecting applied voltage inputted from the boosting unit, and
a current abnormality detecting unit for detecting the abnormality of the current of the motor driving unit on the basis of the boosted output voltage transmitted from the boosting unit and the applied voltage detected by the applied voltage detecting unit.

8. The controller for a motor to be mounted on a vehicle according to claim 6, wherein
the motor driving unit includes:
an estimated voltage calculating unit for calculating an estimated boosted output voltage of the boosting unit in accordance with the boosted voltage control command determined by the boosted voltage control command determining unit, and
a boosted voltage abnormality detecting unit for detecting the abnormality of the boosting unit on the basis of the estimated boosted output voltage calculated by the estimated voltage calculating unit and the boosted output voltage transmitted from the boosting unit.

9. The controller for a motor to be mounted on a vehicle according to claim 1, wherein
the communication unit performs a serial data communication.

10. The controller for a motor to be mounted on a vehicle according to claim 1, wherein
the communication unit performs an optical data communication.

11. The electric power steering device on which the controller for a motor to be mounted on a vehicle according to claim 1 is mounted.

12. The electric brake device on which the controller for a motor to be mounted on a vehicle according to claim 1 is mounted.

13. A controller for a motor to be mounted on a vehicle comprising:
a boosting circuit part disposed in the vicinity of a battery mounted on the vehicle to raise the output voltage of the battery: and
a driving control part disposed in the vicinity of a motor to which a driving power is supplied by the battery to PWM control the drive of the motor in accordance with the voltage boosted by the boosting circuit part.

14. The controller for a motor to be mounted on a vehicle according to claim 13, further comprising:
a communication unit for performing a communication between the boosting circuit part and the driving control part.

15. The controller for a motor to be mounted on a vehicle according to claim 14, wherein
the driving control part transmits a boosted voltage command to the boosting circuit part through the communication unit.

16. The controller for a motor to be mounted on a vehicle according to claim 14, wherein
the boosting circuit part transmits the detected result of a battery voltage to the driving control part through the communication unit.

17. The controller for a motor to be mounted on a vehicle according to claim 14, wherein
the boosting circuit part transmits the detected result of a battery current to the driving control part through the communication unit.

18. The controller for a motor to be mounted on a vehicle according to claim 14, wherein
the driving control part includes a deciding unit for deciding an abnormality of the boosting circuit part in accordance with the compared result of the boost voltage command with the detected boosted voltage.

19. The controller for a motor to be mounted on a vehicle according to claim 17, wherein
the driving control part controls a quantity of current supplied to the winding of the motor in accordance with the detected result of the battery current transmitted from the boosting circuit part.

20. The controller for a motor to be mounted on a vehicle according to claim 13, wherein
the driving control part controls a three-phase motor to be driven.

21. The controller for a motor to be mounted on a vehicle according to claim 20, wherein
the three-phase motor is a brush-less motor.

22. The controller for a motor to be mounted on a vehicle according to claim 20, wherein
the driving control part detects the rotating position of a rotor in the three-phase motor by using a resolver disposed in the three-phase motor and performs a PWM control in accordance with the rotating position.

23. The controller for a motor to be mounted on a vehicle according to claim 13, wherein
the driving control part includes:
power circuit for generating a controlling power source from the battery voltage.

24. The power steering device including the controller for a motor to be mounted on a vehicle according to claim 13, wherein
a steering drive is assisted by the output torque of the motor.
